(19) United States
(12) Patent Application Publication
(10) Pub. No.: US 2023/0401331 A1
(43) Pub. Date: Dec. 14, 2023

(54) SECURE AND SCALABLE PRIVATE SET INTERSECTION FOR LARGE DATASETS

(71) Applicant: Visa International Service Association, San Francisco, CA (US)

(72) Inventors: Minghua Xu, Austin, TX (US); Mihai Christodorescu, Belmont, CA (US); Wei Sun, San Francisco, CA (US); Peter Rindal, San Francisco, CA (US); Ranjit Kumaresan, Sunnyvale, CA (US); Vinjith Nagaraja, Pflugerville, CA (US); Karankumar Hiteshbhai Patel, Austin, TX (US)

(73) Assignee: Visa International Service Association, San Francisco, CA (US)

(21) Appl. No.: 18/044,060

(22) PCT Filed: Oct. 6, 2021
(86) PCT No.: PCT/US2021/053840

§ 371 Date: Mar. 3, 2023

Related U.S. Application Data
(60) Provisional application No. 63/088,863, filed on Oct. 7, 2020.

(51) Int. Cl. G06F 21/62; G06F 21/60

(52) U.S. Cl. CPC G06F 21/6227; G06F 21/602; G06F 21/6254

(57) ABSTRACT

Embodiments of the present disclosure are directed to methods and systems used to determine private set intersections (PSIs) and execute private database joins (PDJs). Some embodiments are characterized by binning techniques that enables PSI and PDJ methods to be performed by worker nodes in a computing cluster in parallel, thus reducing execution time. A first party computing system and a second party computing system can each tokenize their respective datasets, then assign the datasets to bins. The bins can each be padded with dummy tokens. Then the first party computing system and second party computing system can execute several Nparallel PSI on pairs of corresponding bins. The results can then be combined to produce a tokenized intersection set, which can then be detokenized to produce the set intersection.

### CROSS REFERENCE TO RELATED APPLICATION

This application is an international application which claims priority to U.S. Provisional Application No. 63/088,863, filed Oct. 7, 2020, the disclosures of which are hereby incorporated by reference in their entirety for all purposes.

### BACKGROUND

The intersection of two more sets comprises elements common to those sets. Determining the intersection of sets is a practice associated with the use of databases and digital data, and has numerous applications. As an example, a non-profit organization may have a dataset corresponding to a list of people who have previously volunteered for the organization, and a dataset comprising members of the organization that live in a particular city. The non-profit organization may determine the intersection of these datasets in order to determine a list of previous volunteers that live in that city. The non-profit organization could then send a mass-communication (such as a text message, email, etc.) to inform those volunteers of a new volunteering opportunity in that city.

Conventionally, determining the intersection of two sets involves comparing the individual elements of those sets. This means that typically full access to both sets is needed to determine the intersection. This may not be a problem if the datasets are owned or controlled by a single party. If however, sets are owned or held by different parties, the parties would need to disclose their sets to each other in order to determine the set intersection. This can be problematic when the sets comprise data that is private or sensitive, such as personally identifying information, medical records, etc.

Fortunately, privacy-preserving methods for determining set intersections exist. Private set intersection (PSI) enables two parties, each holding a private set of elements, to compute the intersection of the two sets while revealing nothing more than the intersection itself. PSI has applications in a variety of settings. For example, PSI can be used to measure the effectiveness of online advertising [39], perform private contact discovery [12, 21, 62], perform privacy-preserving location sharing [50, 31], perform privacy-preserving remote diagnostics and detect botnets [49]. Several recent works, most notably [11, 54, 55] have studied the balance between computation and communication. Some have even optimized PSI protocols based on the cost of operating these protocols in the cloud.

While progress has been made in advancing the efficiency of PSI protocols, almost all documented research on balanced PSI (e.g., where each party possesses private sets comprising approximately the same number of elements) has focused on settings with set sizes of at most 2²⁴≈16 million elements. One notable exception is the work of which demonstrated the feasibility of non-standard “server aided” PSI on billion element sized sets. In this work, a mutually trusted third party server aided in determining the intersection. Another notable exception is the recent work of [59, 60]. In this work, two servers (each with over 16 GB of memory) determined the PSI of two one billion element sets in 34.2 hours. This result leaves room for improvement.

Additionally, there are many issues associated with scaling existing PSI protocols to large data sets, such as memory consumption. Broadly speaking, memory consumption is a problem when implementing cryptographic schemes that operate on large amounts of data. Many if not all implemented PSI protocols (e.g., those based on garbled circuits, or bloom filters, or cuckoo hashing) quickly exceed the main memory, thereby requiring more engineering effort. Even computing the plaintext intersection for billions of elements is a nontrivial problem.

Embodiments address these and other problems, individually and collectively.

### SUMMARY

Embodiments of the present disclosure are directed to improved methods for determining private set intersections (PSIs) in parallel. These methods are fast and efficient, particularly for determining the PSI of large (e.g., billion element sets). As an example, these methods have been used to determine the PSI of two one-billion-element sets comprising 128 bit elements in 83 minutes; this is 25 times faster than a current state-of-the-art solution described in [60], which determined the same PSI in 34.2 hours. Additionally, because embodiments of the present disclosure can be used to parallelize most existing methods of determining PSIs, they are comparatively flexible and easy to implement.

Embodiments of the present disclosure are also directed to improved methods of performing private database joins (PDJs), based largely on the improved methods for performing PSIs referenced above. In broad terms, a “join query” (e.g., an SQL statement or a JSON style request) can be re-interpreted as a PSI operation between sets of “join keys.” The methods herein can be used to determine an intersected set of join keys, which can then be used to produce the joined table, thereby completing the PDJ.

Embodiments of the present disclosure are also directed to systems, computers, and other devices that can be used to perform the methods described above. These systems can comprise, for example, an orchestrator computer that interprets requests from clients (corresponding to PSIs or PDJs) and transmits them to a first party server and a second party server, each associated with a corresponding database and corresponding computing cluster. The first party server and second party server can communicate with one another and their respective computing clusters to calculate the result of the PSI or PDJ and return the result to the orchestrator, which can then return the result to the client computer.

More specifically, one embodiment is directed to a method performed by a first party computing system. The first party computing system can tokenize a first party set, thereby generating a tokenized first party set. The tokenized first party set can comprise a plurality of first party tokens. The first party computing system can then generate a plurality of tokenized first party subsets by assigning each first party token of the plurality of first party tokens to a tokenized first party subset of the plurality of tokenized first party subsets using an assignment function. Then, for each tokenized first party subset of the plurality of tokenized first party subsets, the first party computing system can perform a private set intersection protocol with a second party computing system using the tokenized first party subset and a tokenized second party subset corresponding to the second party computing system. This this way the first party computing system can perform a plurality of private set intersection protocols and generate a plurality of intersected token subsets. Afterwards, the first party computing system can combine the plurality of intersected token subsets, thereby generating an intersected token set, then detokenize the intersected token set, thereby generating an intersected set.

Another embodiment is directed to a different method performed by a first party computing system. The first party computing system can receive a private database table join query that identifies one or more first database tables and one or more attributes. The first party computing system can retrieve the one or more first database tables from a first party database, then determine a plurality of first party join keys based on the one or more first database tables and one or more attributes. Next, the first party computing system can tokenize the plurality of first party join keys, thereby generating a tokenized first party join key set, wherein the tokenized first party join key set comprises a plurality of first party tokens. The first party computing system can generate a plurality of tokenized first party subsets by assigning each first party token of the plurality of first party tokens to a tokenized first party subset of the plurality of tokenized first party subsets using an assignment function.

Then for each tokenized first party subset of the plurality of tokenized first party subsets, the first party computing system can perform a private set intersection protocol with a second party computing system using the tokenized first party subset and a tokenized second party subset corresponding to the second party computing system, thereby performing a plurality of private set intersection protocols and generating a plurality of intersected token subsets. The first party computing system can combine the plurality of intersected token subsets, thereby generating an intersected join key set, then detokenize the intersected token set, thereby generating an intersected join key set. Afterwards, the first party computing system can filter the one or more first database tables using the intersected join key set, thereby generating one or more filtered first database tables. The first party computing system can receive one or more filtered second database tables from the second party computing system, then combine the one or more filtered first database tables and the one or more filtered second database tables, thereby generating a joined database table.

These and other embodiments of the disclosure are described in detail below. For example, other embodiments are directed to systems, devices, and computer readable media associated with methods described herein.

Prior to discussing specific embodiments of the disclosure, some terms may be described in detail.

### TERMS

A “server computer” may include a powerful computer or cluster of computers. For example, the server computer can include a large mainframe, a minicomputer cluster, or a group of servers functioning as a unit. In one example, the server computer can include a database server coupled to a web server. The server computer may comprise one or more computational apparatuses and may use any of a variety of computing structures, arrangements, and compilations for servicing the requests from one or more client computers.

An “edge server” may refer to a server that is located on the “edge” of a computing domain or network. An edge server may communicate with computers located both within the computing network and outside of the computing network. An edge server may allow external computers (such as client computers) to gain access to resources or services provided by the computing domain or network.

A “client computer” may refer to a computer that uses the services of other computers or devices, such as server computers. A client computer may connect to these other computers or devices over a network such as the Internet. As an example, a client computer may comprise a laptop computer that connects to an image hosting server in order to view images stored on the image hosting server.

A “memory” may refer to any suitable device or devices that may store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “processor” may refer to any suitable data computation device or devices. A

processor may comprise one or more microprocessors working together to accomplish a desired function. The processor may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “hash function” may refer to any function that can be used to map data of arbitrary length or size to data of fixed length or size. A hash function may be used to obscure data by replacing it with its corresponding “hash value.” Hash values may be used as tokens.

A “token” may refer to data used as a substitute for other data. A token may comprise a numeric or alphanumeric sequence. A token may be used to obscure data that is secret or sensitive. The process of converting data into a token may be referred to as “tokenization.” Tokenization may be accomplished using hash functions. The process of converting a token into the substituted data may be referred to as “detokenization.” Detokenization may be accomplished via a mapping (such as a look-up table) that relates a token to the data it substitutes. A “reverse-lookup” may refer to a technique that can be used to determine substituted data based on tokens using a mapping.

A “dummy value” may refer to a value with no meaning or significance. A dummy value may be generated using a random or pseudorandom number generator. A dummy value may comprise a “dummy token,” a token that does not correspond to any substituted data.

A “multi-party computation” (MPC) may refer to a computation that is performed by multiple parties. Each party, such as a computer, server, or cryptographic device, may have some inputs to the computation. Each party can collectively calculate the output of the computation using the inputs.

A “secure multi-party computation” (secure MPC) may refer to a multi-party computation that is secure. In some cases, “secure multi-party computation” refers to a multi-party computation in which the parties do not share information or other inputs with each other. Determining a PSI can be accomplished using a secure MPC.

An “oblivious transfer (OT) protocol” may refer to a process by which one party can transmit a message (or other data) to another party without knowing what message was transmitted. OT protocols may be 1-out-of-n, meaning that a party can transmit one of n potential messages to another party without knowing which of the n messages was transmitted. OT protocols can be used to implement many forms of secure MPC, including PSI protocols.

A “pseudorandom function” may refer to a deterministic function that produces an output that appears random. Pseudorandom functions may include collision resistant hash functions, elliptic curve groups, etc. A pseudorandom function may approximate a “random oracle,” an ideal cryptographic primitive that maps an input to a random output from its output domain. A pseudorandom function can be constructed from a pseudorandom number generator.

An “oblivious pseudorandom function” (OPRF) may refer to a function that delivers a pseudorandom output to a first party using a pseudorandom function and an input provided by a second party. The first party may not learn the input and the second party may not learn the pseudorandom output. An OPRF can be used to implement many forms of secure MPC, including PSI protocols.

A “message” may refer to any data that may be transmitted between two entities. A message may comprise plaintext data or ciphertext data. A message may comprise alphanumeric sequences (e.g., “hello123”) or any other data (e.g., images or video files). Messages may be transmitted between computers or other entities.

A “log file” or “audit log” may comprise a data file that stores a record of information. For example, a log file may comprise records of use of a particular service, such as a private database join service. A log file may contain additional information, such as a time associated with the use of the service, an identifier associated with a client using the service, the nature of the use of the service, etc.

### BRIEF DESCRIPTION OF THE DRAWINGS

FIG. 1 shows an exemplary use case for a PDJ according to some embodiments.

FIG. 2 shows an exemplary PPSI and PPDJ system according to some embodiments.

FIG. 3 shows a high level description of PSI parallelization according to some embodiments.

FIG. 4 shows an exemplary PPSI method according to some embodiments, including binning.

FIG. 5 shows a flowchart corresponding to an exemplary PPSI method according to some embodiments, including binning.

FIG. 6 shows a flowchart corresponding to an exemplary PPDJ method according to some embodiments.

FIG. 7 shows a system block diagram of an exemplary SPARK-PSI system according to some embodiments.

FIG. 8 shows a diagram detailing a SPARK-PSI workflow according to some embodiments.

FIG. 9 shows a graph summarizing results from a SPARK-PSI benchmarking experiment.

FIG. 10 shows an exemplary computer system according to some embodiments.

### DETAILED DESCRIPTION

Embodiments of the present disclosure relate to improved implementations of oblivious transfer (OT) based PSI protocols that can be used to quickly determine the PSI of sets comprising large numbers (e.g., billions) of elements. A benchmarking experiment performed using these protocols (see Section VII) was used to determine the PSI of two sets, each comprising one billion 128-bit elements. The PSI was determine in roughly 83 minutes.

By comparison, a naive hashing protocol for standard set intersection requires 74 minutes to complete, of which 19 minutes (26%) are for hashing and transferring data and 55 minutes (74%) are for computing the plaintext intersection. Thus in terms of execution time, a paralleled PSI (PPSI) protocol according to embodiments only slightly underperforms insecure set intersection protocols.

As an additional comparison, the work of determined the PSI of two one billion element sets containing 128-bit elements in 34.2 hours using solid state drives. 30.0 hours (88%) was spent performing simple hashing. 3 hours (9%) was spent computing the OTs, 1.2 hours (4%) was spent computing the plaintext intersection. Thus, a PPSI protocol according to embodiments can determine PSIs approximately 25 times faster than current, state-of-the-art solutions.

Embodiments achieve these results by use of novel techniques that enable PSI protocols to be parallelized. In this manner, parties (e.g., computer systems storing private sets) can distribute their computational workload among multiple worker nodes in computing clusters (using for example, a large-scale data processing engine such as Apache Spark), reducing the total amount of time required to calculate the PSI. Further, these parallelization techniques can be used with many different existing PSI protocols (such as KKRT [41], PSSZ15 [56], etc.) without otherwise modifying those protocols. As such, embodiments can comprise a “plug and play” solution, which may be easier for entities and organizations to integrate into existing PSI systems or infrastructure.

This disclosure describes the following aspects. In aspect (1), “binning” can be used to securely produce tokenized subsets based on input datasets. In aspect (2), “parallel private set intersection (PPSI) techniques” (sometimes referred to as a PPSI protocol or π_{PPSI}) can be used by a first party and a second party to determine the private set intersection of a first set and a second set. The PPSI techniques can involve the use of the binning techniques described above. In aspect (3), “parallel private database join (PPDJ)” techniques (sometimes referred to as a PPDJ protocol) can be used by a first party and a second party to perform a private join of one or more first database table and one or more second database table. In aspect (4), a “PPSI or PPDJ system,” comprising computers and other devices, can be used to perform either the PPSI techniques or the PPDJ techniques. In aspect (5), an implementation of the PPSI or PPDJ system, referred to as “SPARK-PSI” can use Apache open source software, particularly Apache Spark. In aspect (6), benchmarking experiments performed on SPARK-PSI, demonstrate its speed and efficiency. In aspect (7), cryptographic threat modelling, analysis, and simulation, can be used to demonstrate the security of the binning techniques, PPSI techniques, etc. In aspect (8), various related works, theory, and additional concepts relevant to the field of PSI are provided, which may aid in understanding embodiments of the present disclosure.

In broad terms, binning can involve tokenizing elements of two sets (e.g., a first party set and a second party set), assigning the tokens to subsets (or “bins”) of roughly equal size, and padding the subsets using random dummy tokens, thereby obscuring the number of real tokens in the subsets. Binning can divide the elements of sets into these subsets securely, without leaking any information about the number or distribution of elements in the sets. In this way binning can enable parallelization of PSI protocols. Rather than performing a single PSI protocol using a (large) first set and a (large) second set, a first party computing system and a second party computing system can perform multiple PSI protocols using pairs of tokenized subsets.

The PPSI techniques can involve an application of the binning techniques described above. A first party computing system and a second party computing system can use binning techniques to partition a first party set and a second party set into a plurality of tokenized first party subsets and a plurality of tokenized second party subsets. The first party computing system and the second party computing system can then perform m PSI protocols (where m is the number of tokenized subsets corresponding to each party), using pairs of corresponding tokenized subsets. These PSI protocols can be performed in parallel using computing clusters that comprise a number of worker nodes. The result of these m PSI protocols can comprise m intersected token subsets. One or both of the first party computing system and the second party computing system can combine the m intersected token subsets to produce a intersected token set. The first party computing system and second party computing system can detokenize the intersected token set, thereby generating an intersected set. In this way the PSI of the first party set and the second party set can be determined.

The PPDJ techniques can involve an application of the PPSI techniques described above. A client computer can transmit a join query (also referred to as a “join request,” a “private database table join query,” and other like terms) to an orchestrator computer. The join query can identify database tables corresponding to the two parties and a set of “attributes” that are the basis of the join operation. In general terms, the orchestrator computer can reinterpret this join query as one or more PSI operations on sets of “join keys.” The reinterpreted join query can be sent to the first party computing system and the second party computing system. The first party computing system and second party computing system can (using their respective computing clusters) perform PPSI techniques using a first party join key set and a second party join key set. This can result in an intersected set of join keys. Using the intersected set of join keys, each party can filter their respective database tables, then transmit the filtered database tables to one another. The filtered database tables can then be combined (joined), thereby completing the PDJ.

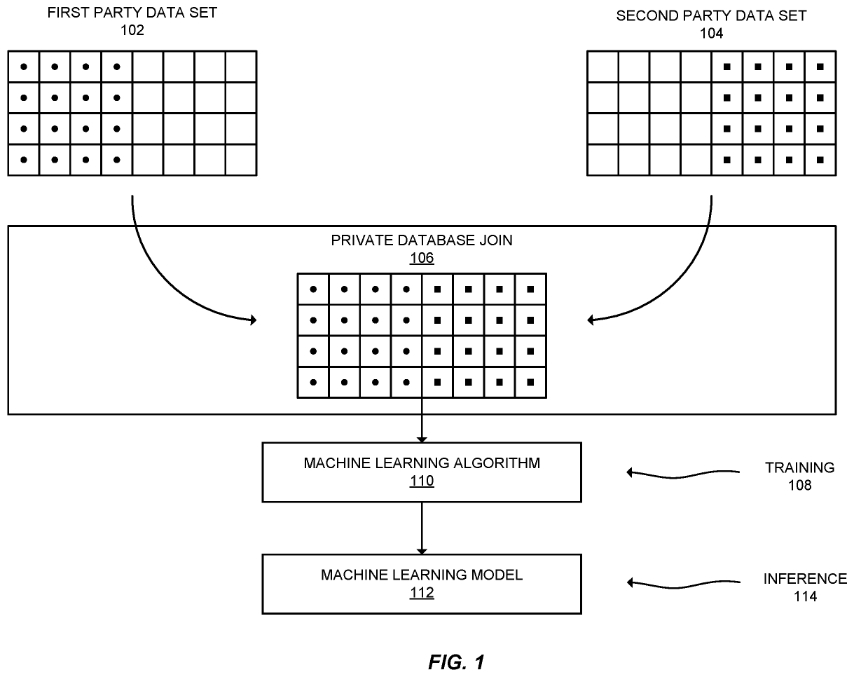

FIG. 1 shows an exemplary use case for a private database join. A first party and a second party can possess a first party data set 102 and a second party dataset 104 respectively. The first party and the second party may want to use their datasets to produce a machine learning model 112. As an example, these data sets may comprise tables of advertising data, and the machine learning model 112 may comprise a model used to predict the effectiveness of an advertising campaign. The first party and the second party each benefit from using the data from the other party to train the machine learning model 112. However, the parties may not want to freely share data with each other.

Instead, the parties can perform a private database join 106 using their respective data sets as inputs. As a result, the two parties can enrich their dataset without revealing any additional information to the other party. During a training phase, the joined dataset can be used as an input to a machine learning algorithm 110. The machine learning algorithm 110 can produce a machine learning model 112. Afterwards, either party can use the machine learning model 112 to make any number of inferences 114 about the data, for example, whether a particular advertising campaign will be effective.

A PPSI or PPDJ system that can be used to implement PPSI techniques and/or the PPDJ techniques is described in more detail in Section I. Generally, this system comprises a client computer, an orchestrator computer, a “first party domain” and a “second party domain.” The first party domain can comprise a first party computing system, which can comprise a first party server and a first party computing cluster. The second party domain can comprise a second party computing system, which can comprise a second party server and a second party computing cluster. The first party server and second party server may be referred to as “edge servers.” Each party can use their respective computing system to perform PPSI or PPDJ techniques with the other party.

It should be understood that there are a variety of ways that can be used to implement the PPSI or PPDJ system described above. Such implementations can use a variety of hardware systems, software packages, frameworks, libraries, etc. However, for illustrative purposes, a particular implementation (SPARK-PSI) using Apache open source software including Apache Spark is described. At the time of writing, Apache open source software is popular in academia, research, and industry for big data applications. As such, SPARK-PSI demonstrates a practical implementation of some embodiments.

Additionally, the SPARK-PSI implementation was used in a series of benchmarking experiments described in Section VII. These benchmarking experiments demonstrate the speed and efficacy of PPSI techniques described herein, particularly when compared to existing state-of-the-art PSI protocols. As an example, the SPARK-PSI implementation performed a parallel private set intersection between two sets, each comprising one billion 128-bit elements in 83 minutes. A current state-of-the-art PSI protocol described in [60], achieved the same result in 34.2 hours. Thus, methods according to embodiments can be used to perform PSI (on large datasets) roughly 25 times faster than current state-of-the-art PSI protocols.

### I. PPSI AND PPDJ SYSTEM

PPSI techniques used to determine the intersection of two sets and PPDJ techniques used to produce joined database tables can be executed respectively by a PPSI and PPDJ system, a network of computers, databases, and other devices that enables two parties to perform a secure private set intersection or a secure private database join.

A. System block diagram

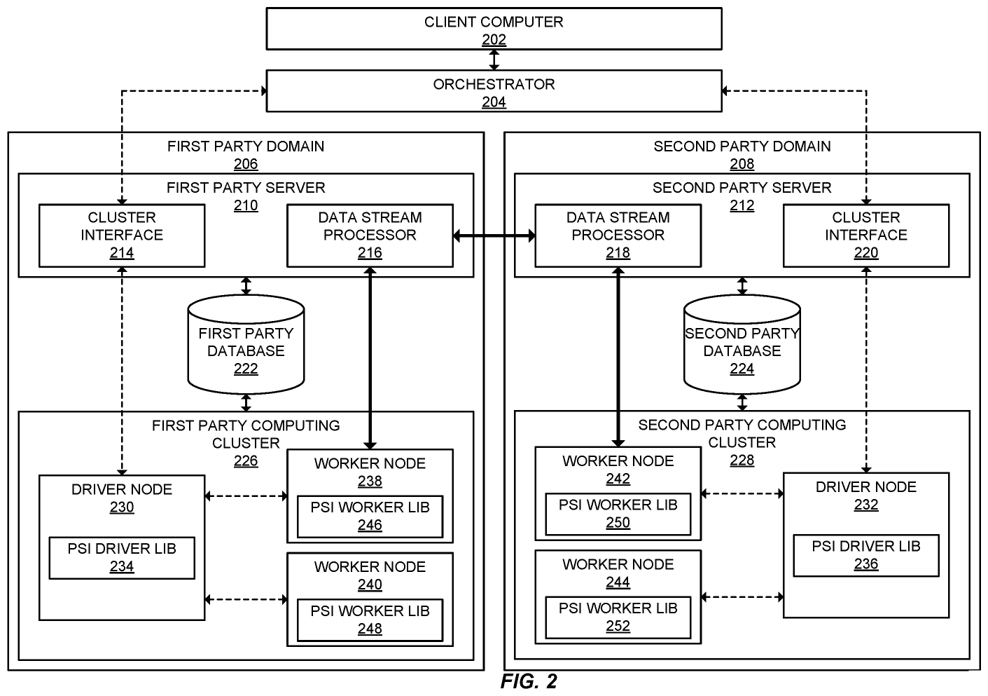

FIG. 2 shows a system block diagram of an exemplary PPSI and PPDJ system according to some embodiments. The system of FIG. 2 comprises a client computer 202, an orchestrator (also referred to as an orchestrator computer) 204, a first party domain 206, and a second party domain 208.

The first party domain 206 and the second party domain 208 broadly comprise the computing resources corresponding to the first party and the second party respectively. The first party domain 206 can comprise a first party server 210, a first party database 222, and a first party computing cluster 226. The second party domain 208 can comprise a second party server 212, a second party database 224, and a second party computing cluster 228. The combination of the first party server 210 and the first party computing cluster 226 may be referred to as a “first party computing system.” Likewise, the combination of the second party server 212 and the second party computing cluster 228 may be referred to as a “second party computing system.”

In some embodiments, the first party computing system and second party computing system may comprise single computer entities, rather than combinations of computer entities, as described above. As such, it should be understood that in these embodiments, messages transmitted or received by, for example, the first party server 210 may instead be transmitted or received by the single computer entity comprising the first party computing system, and likewise for the second party computing system.

The computers and devices of FIG. 2 may communicated with each other via a communication network, which can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers and devices may be transmitted using a secure communications protocol, such as, but not limited to, File Transfer Protocol (FTP); HyperText Transfer Protocol (HTTP); Secure HyperText Transfer Protocol (HTTPS); Secure Socket Layer (SSL), ISO (e.g., ISO 8583) and/or the like.
1. Client Computer

The client computer 202 can comprise a computer system associated with a client. The client may request the output of a PPSI on two datasets (an intersected set) or the output of a PPDJ (a joined table). The client may use client computer 202 to request this output by transmitting a request message to orchestrator 204. When the client computer 202 is used to request the output of a PPDJ, the request message may comprise a database query, such as an SQL style query. Alternatively, the request message may comprise a JSON request. The client computer 202 may be a computer system associated with either the first party or the second party. After a PSI is determined or a PPDJ operation completed, the client computer 202 can receive the results from the orchestrator 204. The client computer 202 may communicate with the orchestrator 204 via an interface exposed by the orchestrator (such as a UI application, a portal, a Jupyter Lab interface, etc.)
2. Orchestrator

The orchestrator computer 204 may comprise a computer system that manages or otherwise directs PPSI and PPDJ operations. The orchestrator 204 can receive request messages from client computers, interpret those request messages, and communicate with the first party server 210 and second party server 212 to complete those requests. For example, if a request message comprises a PDJ query, the orchestrator can validate the correctness of the PDJ query, reinterpret that query as PPSI operations, and then transmit a request message detailing those operations to the first party server 210 and the second party server 212. Messages from the orchestrator to the first party server 210 and the second party server 212 may, for example, identify particular datasets on which the first party server 210 and the second party server 212 should perform PPSI or PPDJ operations on.

These messages may also include metadata or data schema that may be useful in performing PPSI or PPDJ operations. The orchestrator computer 204 may acquire these metadata and schemas during an initialization phase performed between the orchestrator 204, the first party server 210, and the second party server 212. During this initialization phase, the first party server 210 and the second party server 212 may transmit their respective metadata and schemas to the orchestrator 204.

The orchestrator 204 can interface with the first party server 210 and the second party server 212 via their respective cluster interfaces 214 and 220. Once the first party computing system and second party computing system have completed the PPSI or PPDJ operation, they can return the results (e.g., an intersected set or a joined database table) to the orchestrator 104 via their respective cluster interfaces. The orchestrator 204 can then return the results to the client computer 202.

Additionally, although the orchestrator 204 is shown outside of the first party domain 206 and second party domain 208, in some implementations the orchestrator 204 may be included in either of these domains, and thus may be operated by the first party or the second party.
3. First and Second Party Server

The first party server 210 and second party server 212 may comprise edge servers located at the “edge” of the first party domain 206 and second party domain 208 respectively. The first party server 210 and second party server 212 may manage PPSI and PPDJ operations performed by their respective computing clusters. The first party server 210 and the second party server 212 may use their respective cluster interfaces 214 and 220 to communicate with their respective computing clusters. In some embodiments, cluster interfaces 214 and 220 can be implemented using Apache Livy. The first party server 210 and second party server 212 may communicate with one another via their respective data stream processors 216 and 218. In some embodiments, data stream processors 216 and 218 can be implemented using Apache Kafka. These data stream processors 216 and 218 may also be used to communicate with worker nodes 238-244.

The first party server 210 may interface with first party database 222 in order to retrieve any relevant sets or database tables used to perform PPSI or PPDJ operations. The first party server 210 can perform binning techniques (described in more detail below) to produce tokenized subsets, which the first party server 210 can transmit to the first party computing cluster 226 (via cluster interface 214 and driver node 230). The first party computing cluster 226 can then perform PPSI techniques on these tokenized subsets, returning a tokenized intersection set. The first party server 210 can then detokenize the tokenized intersection set, producing an intersection set, which can be returned to the client computer 202 via the orchestrator 204. Alternatively, if the first party server 210 is performing a PDJ operation, the first party server can use the intersection subset to produce a joined database table, which can then be returned to the client computer 202 via the orchestrator 204.

Likewise, the second party server 212 may interface with second party database 224 in order to retrieve any relevant sets or database tables used to perform PPSI or PPDJ operations. The second party server 212 can perform the binning techniques (described in more detail below) to produce tokenized subsets, which the second party server 212 can transmit to the second party computing cluster 228 (via cluster interface 220 and driver node 232). The second party computing cluster 228 can then perform PPSI techniques on these tokenized subsets, returning a tokenized intersection set. The second party server 212 can then detokenize the tokenized intersection set, producing an intersection set, which can be returned to the client computer 202 via the orchestrator 204. Alternatively, if the second party server 212 is performing a PDJ operation, the second party server 212 can use the intersection subset to produce a joined database table, which can then be returned to the client computer 202 via the orchestrator 204.
4. First and Second Party Database

The first party database 222 and second party database 224 may comprise databases that store datasets (sometimes referred to as “first party sets” and “second party sets”) and database tables (sometimes referred to as “first party database tables” and “second party database tables”). The first party computing system and second party computing systems may access their respective databases to retrieve these datasets and database tables in order to perform PPSI and PPDJ operations. Notably, the first party database 222 can be isolated from the second party domain 208. Likewise, the second party database 224 can be isolated from the first party domain 206. This can prevent either party from accessing private data belonging to the other party.
5. First and Second Party Computing Cluster

The first party computing cluster 226 and second party computing cluster 228 may comprise computer nodes that can execute PSI protocols in parallel in order to execute PPSI techniques according to embodiments. These may include driver nodes 230 and 232 (also referred to as master nodes), and worker nodes 238-244. Each node may store code enabling it to execute its respective functions. For example, driver nodes 230 and 232 may each store a respective PSI driver library 234 and 236. Likewise, worker nodes 238-244 may store PSI worker libraries 246-252. The worker nodes 238-244 may use these PSI worker libraries to perform a plurality of private set intersection protocols in order to produce a plurality of intersected subsets, which may then be combined to produce an intersected set.

In broad terms, the driver nodes 230 and 232 can distribute computational workload among the worker nodes in their respective computing clusters. This may include workload relating to determining the PSI of tokenized subsets. For example, driver node 230 may assign a particular tokenized subset i to worker node 238, and may identify a corresponding worker node in the second party computing cluster 228. Worker node 238 is thus tasked to perform a PSI protocol with the corresponding worker node using the tokenized subset i. When it has completed its task, worker node 238 can return the result to driver node 230, and driver node 230 can assign a new tokenized subset j to the worker node. This process can be repeated until the intersection of each tokenized subset has been determined. The driver node 230 can then combine these tokenized intersection subsets to produce a tokenized intersection set, then transmit the tokenized intersection set to the first party server 210. Alternatively, the driver node 230 can transmit the tokenized intersection subsets to the first party server 210, which can then perform the combination process itself.

### B. General PPSI and PPDJ System Dataflow

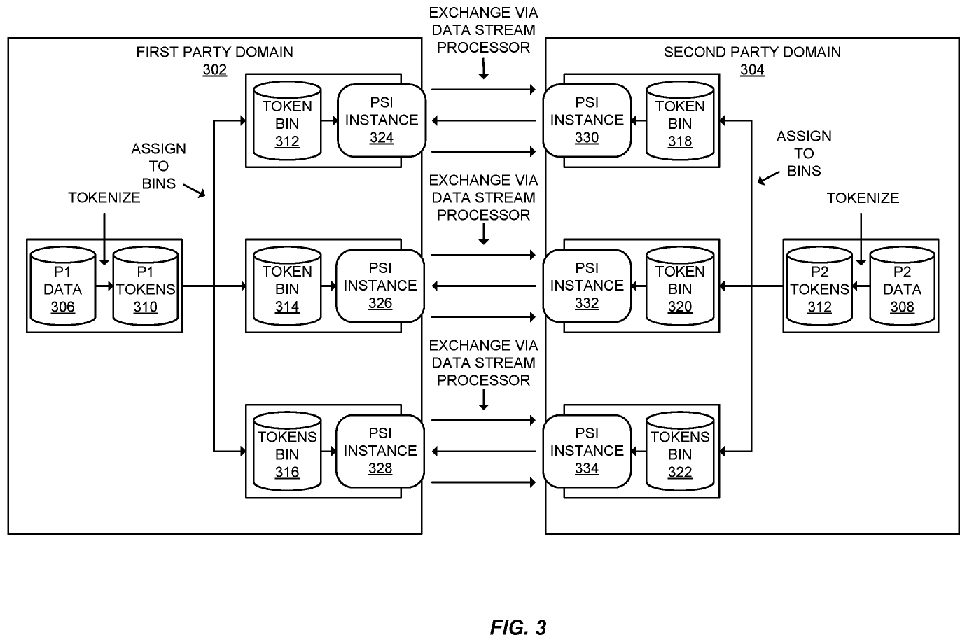

FIG. 3 shows an exemplary dataflow corresponding to a PPSI and PPDJ system. FIG. 3 also generally corresponds to some methods according to embodiments. A first party computing system within a first party domain 302 and a second party computing system within a second party domain 304 can each tokenize their respective data sets (first party data set 306 and second party data set 308), thereby creating a tokenized first party dataset 310 and a tokenized second party data set 312. The first party computing system and second party computing system can then map their respective tokens to token bins 312-322. These token bins can each be assigned to a different worker node of a plurality of worker nodes. The worker nodes 312-322 can execute multiple PSI protocol instances 324-334 across the first party domain 302 and second party domain 304. When data exchanges are necessary to perform the PSI protocols, the worker nodes can exchange data via a data stream processor (e.g., data stream processors 216 and 218 from FIG. 2). These PSI instances 324-334 can result in a plurality of intersected token subsets, which can then be combined and detokenized to produce the intersected data set. This process is described in more detail with reference to Sections II and III below.

### II. BINNING

As stated above, binning techniques can be used by to tokenize a first party set and a second party set, which can each comprise n elements, then separate the tokenized first party set and second party set into m tokenized subsets or “bins.” Afterwards, the two parties can pad each tokenized subset with dummy tokens. In some cases, the parties can pad each tokenized subset with dummy tokens to ensure that each subset contains (1 +8 0)n/m tokens for some parameter δ₀. A subset can also be referred to as a “partition.”

After performing binning techniques, the first party and the second party can perform a series of PSI protocols (e.g., the KKRT protocol) on each corresponding pair of tokenized subsets. The results, a plurality of intersected token subsets, can be combined to produce an intersected token set. This intersected token set can then be detokenized, producing an intersected set.

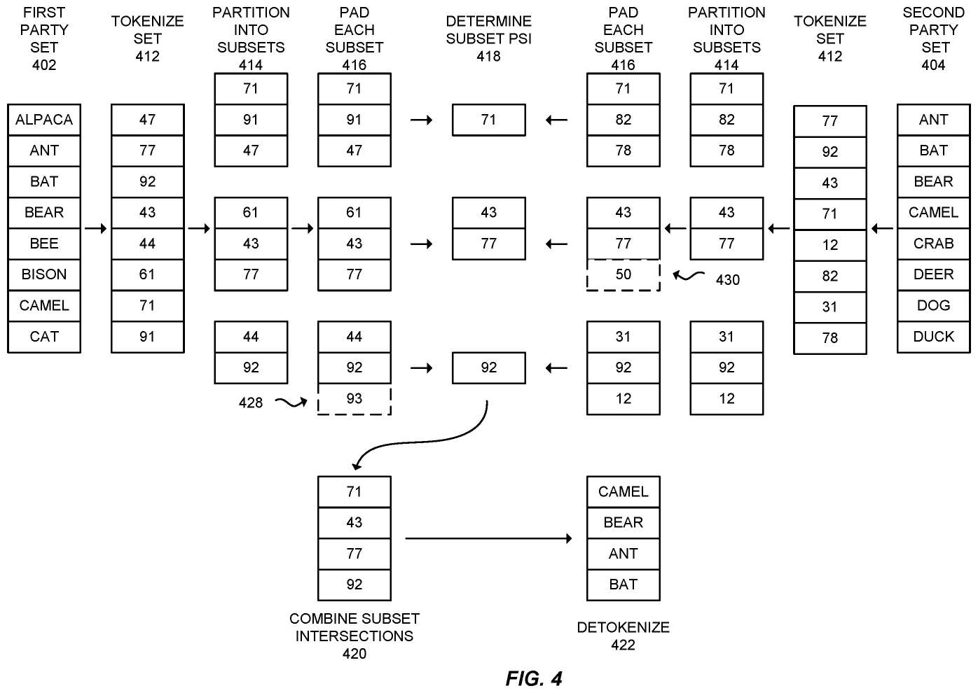

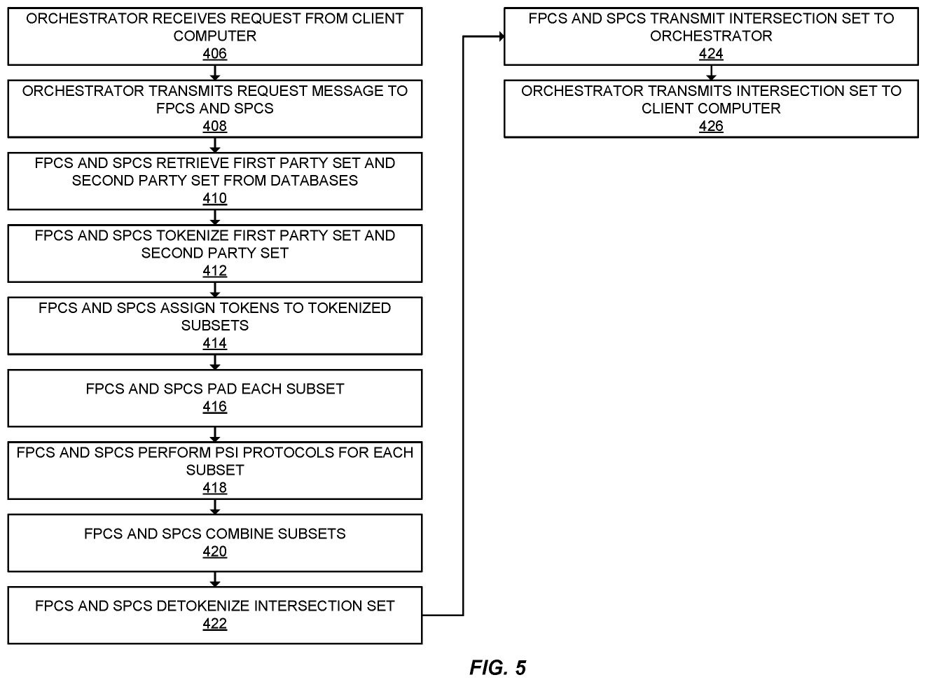

PPSI techniques, which may include applications of binnings, can be better understood with reference to FIGS. 4 and 5, which shows a process used to determine the PSI of a first party set 402 and a second party set 404, each set comprising a list of animals. One or more steps in this process may be optional. The first party set 402 and second party set 404 may comprise data records stored in a first party database and second party database respectively. Each record can include additional data fields corresponding to the respective animal (e.g., weight, country of origin, etc.).

Referring to FIGS. 4 and 5, at step 406, an orchestrator computer may receive a request from a client computer. The request may indicate that a client computer wants to receive the intersection of the first party set 402 and second party set 404.

At step 408, the first party computing system and second party computing system can receive a request message from the orchestrator computer. The request message may correspond to the request received by the orchestrator from the client computer. The request may indicate the first party set 402 and second party set 404. In this way, the first party computing system and second party computing system know which sets to perform PPSI on.

At step 410, the first party computing system can retrieve the first party set 402 from a first party database (such as first party database 222 from FIG. 2). Likewise, the second party computing system can retrieve the second party set 404 from a second party database. In some embodiments, the first party set 402 and the second party set 404 may comprise an equal number of elements (referred to as “first party elements” and “second party elements”). This number of elements may be denoted n.

### A. Tokenization

At step 412, the first party computing system and the second party computing system can tokenize the first party set 402 and second party set 404 respectively, thereby generating a tokenized first party set and a tokenized second party set. The tokenized first party set may comprise a plurality of “first party tokens.” Likewise, the tokenized second party set may comprise a plurality of “second party tokens.”

The first party computing system and second party computing system can use any appropriate means to tokenize the first party set 402 and second party set 404, provided that the means is consistent, i.e., when the two parties tokenize identical data elements (such as “CAMEL”) they produce identical tokens.

As an example, the first party computing system and the second party computing system can tokenize their respective sets using a collision resistant hash function. The first party computing system can generate a plurality of hash values by hashing each first party element using the hash function. The tokenized first party set can comprise this plurality of hash values. Likewise, the second party computing system can generate a second plurality of hash values by hashing each second party element, and the tokenized second party set can comprise this second plurality of hash values. The computing systems can then generate a mapping that relates their tokens to the original set elements. This mapping can comprise, for example, pairs of values corresponding to tokens and their original set elements. This mappings can later be used to perform detokenization via reverse lookup, at e.g., step 422.

### B. Subset Assignment

Afterwards, at step 414, the first party computing system and second party computing system can partition their respective tokenized sets into a plurality of tokenized subsets. As an example, the first party computing system can generate a plurality of tokenized first party subsets by assigning each first party token of the plurality of first party tokens to a tokenized first party subset of the plurality of tokenized first party subsets using an assignment function. Likewise, the second party computing system can generate a plurality of second party tokenized subsets by assigning each second party token of the plurality of second party tokens to a tokenized second party subset of a plurality of tokenized second party subsets using an assignment function. In some embodiments, each party may generate an equal number of tokenized subsets. This may comprise a predetermined number of subsets, which may be denoted m.

As stated above, the computing systems can use an assignment function to perform the subset assignment. There are many potential assignment functions that can be used. However, ideally the assignment function matches tokens to subsets consistently. That is, if the first party computing system maps a token to a particular subset, the second party computing system should map the same token to the corresponding subset.

As an example, in some embodiments, the assignment function can comprise a lexicographical ordering function that maps to a tokenized subset T₁, . . . , Tₘ based on a lexicographical ordering of the tokens. The first party computing system can use this assignment function to assign each first party token of the plurality of first party tokens to a corresponding tokenized first party subset based on the lexicographical ordering of the plurality of first party tokens. For example, one subset could comprise numerical tokens that begin with the digit “1”, another subset could comprise numerical tokens the begin with the digit “2”, etc. The same process can be performed by the second party computing system. Assuming that the tokens were generated using a hash function with roughly uniform pseudorandomness, each subset can comprise roughly n/m elements.

Another example technique is hash-based assignment. The first party computing system and the second party computing system can each locally sample a random hash function h: {0,1}*→{1, . . . , m}. Note that this hash function h should be distinct from any hash function used to generate the tokenized sets. The hash function h can take in any value (such as a token) and return a value from 1 to m inclusive. Each party can transform its tokenized set S={s₁, . . . , sₙ} into subsets T₁, . . . , Tₘ such that for all s ∈S it holds that s ∈ Tₕ₍ₛ₎. In other words, each tokenized first (and second) party subset can be associated with a numeric identifier between one and a predetermined number of subsets m, inclusive. The assignment function can comprise a hash function h that produces hash values between one and the predetermined number of subsets m, inclusive. The first party computing system can assign each first party token of the plurality of first party tokens to a tokenized first party subset by generating a hash value using the first party token as an input to the hash function h and assigning the first party token to a tokenized first party subset with a numeric identifier equal to the hash value. The second party computing system can perform a similar process. Modeling h as a random function ensures that the elements {h(s)|s ∈S} are all distributed uniformly. This implies that [symbol] [sizeof Tᵢ]=n/m.

### C. Subset Padding

Afterwards, at step 416, the first party computing system and second party computing system can pad each of their respective plurality of tokenized subsets using dummy tokens. For the purpose of example, two dummy tokens 428 and 430 are shown. Subset padding prevents either party from determining any information about the other party's set based on the number of tokens in each subset. For example if a tokenized first party subset Tᵢ does not contain any tokens, it implies that the first party set S does not contain any elements that would be assigned to that subset after tokenization. However, with padded subsets, neither party can determine the distribution of the other party's set.

The first party computing system and second party computing system can pad each of their tokenized subsets with uniform random dummy tokens. In some embodiments, the computing systems may pad each tokenized subset with dummy tokens such that the size of each tokenized subset is equal. In some embodiments, the computing systems may pad each tokenized subset with dummy tokens such that the size of each tokenized subset equals (1+δ₀)n/m tokens for some parameter δ₀.

In some embodiments, the first party computing system can determine a padding value for each tokenized first party subset of the plurality of tokenized first party subsets. This padding value can comprise the difference between the size of the tokenized first party subset and a target value. This target value can comprise, e.g., the value (1+δ₀)n/m from above. The padding value then comprises the number of dummy tokens that can be added to that particular tokenized subset to achieve the target value. The first party computing system can generate a plurality of random dummy tokens (using, e.g., a random number generator), where the plurality of random dummy tokens comprise a number of random dummy tokens equal to the padding value. The first party computing system can then assign the plurality of random dummy tokens to the tokenized first party subset. The first party computing system can repeat this process for each tokenized first party subset. The second party computing system can perform a similar procedure.

Even for relatively small tokens (e.g., with length κ=128 bits), there are a large number (2^{κ}) of possible dummy tokens, and thus the probability of any dummy tokens being in a tokenized intersection set is negligible. Alternatively, if κ is large enough, the first party computing system and second party computing system can pad their j-th subsets with dummy tokens s′ sampled from non-overlapping subsets of {0,1}^{κ} such that h(s′)=j′≠j. This ensures that no dummy token is in the tokenized intersection set.

The value of the parameter the parameter δ₀ that ensures that the subset assignment step does not fail except with negligible probability is computed below. For a fixed i ∈[n] and j ∈{1, . . . , m}, suppose X_{i,j} is the indicator variable that equals 1 iff the i-th element sᵢ ended up in Tⱼ, and suppose Xⱼ=Σ_{i∈[n]}X_{i,j} denotes the size of Tⱼ. For a fixed j, since X_{i,j} variables are independent of each other (since h is modeled as a random function), a Chernoff bound yields [symbol] [Xⱼ>(1+δ)μ]≤e^{-δ}^{²}^{μ/3} where μ= [symbol] [Xⱼ]=n/m and 0≤δ≤1 (For a single bin Tⱼ). By union bound, the probability that any of the bins have greater than (1+δ)μ elements is ≤me^{-δ}^{²}^{μ/3}. Thus if the failure probability is set to me^{-δ}^{²}^{/3m}=2^{-σ}, the result is

$$δ = \sqrt{3 m / n \cdot ( σ ln 2 + ln m )} {=}^{def} {δ}_{0} .$$

That is, the above binning techniques require only max bin size at most (1+δ₀)n/m with high probability. More concretely, suppose set size n=10⁹ and statistical parameter σ=80, then choosing parameter m=64, it can be shown that the max bin size of any of the 64 bins is at most n′≈15.68×10⁶ (with δ₀=0.0034) with probability (1−2⁻⁸⁰).

### III. PPSI

After assigning the tokenized elements to subsets and padding those subsets, at step 418 the first party computing system and second party computing system can engage in m parallel instances of a PSI protocol π, where in the i-th instance πᵢ, the first party computing system and second party computing system input their respective i-th padded tokenized subsets. That is, for each tokenized first party subset of the plurality of tokenized first party subsets, the first party computing system can perform a private set intersection protocol with the second party computing system using the tokenized first party subset and a tokenized second party subset corresponding to the second party computing system. In this manner, the first party computing system and second party computing system can perform a plurality of private set intersection protocols and generate a plurality of intersected token subsets.

The first party computing system and second party computing system can use any appropriate PSI protocol π. One notable PSI protocol is KKRT [41], which at the time of writing is one of the fastest and most efficient PSI protocols. However, embodiments can be practiced with any underlying PSI protocol, such as PSSZ15 [56], PSWW18 [57], etc.

At step 420, the first party computing system and second party computing system can each combine the plurality of tokenized intersection subsets, thereby generating a tokenized intersection set. This tokenized intersection set can comprise a union of the plurality of token intersection subsets. Thus combining the plurality of intersected token subsets can comprise determining the union of the plurality of intersected token subsets.

Afterwards, at step 422, the first party computing system and second party computing system can detokenize the tokenized intersection set, producing an intersection set. The intersection set can comprise the elements common to the first party set 402 and the second party set 404. In the example of FIG. 4, this can comprise the set {CAMEL, BEAR, ANT, BAT}. In this way the two parties can learn the intersection of their respective sets without learning the other elements in those sets.

At optional step 424, if the set intersection was requested by an orchestrator computer or a client computer communicating with the orchestrator computer, the first party computing system (and optionally the second party computing system) can transmit the intersected set to the orchestrator computer. Subsequently, at optional step 426, the orchestrator computer can transmit the intersected set to the client computer.

### IV. THREAT MODELING AND SECURITY SIMULATION

A. Threat Modelling

This section considers a semi-honest adversary and detail its capabilities with respect to PPSI techniques deployed on a computing cluster (such as a Spark cluster) and to big data frameworks (such as the Spark framework).

In standard cryptography terminology, it is assumed that the underlying PSI protocol is secure against “semi-honest” (otherwise known as honest-but-curious) adversaries. That is, it is expected the parties and their respective computing systems faithfully follow the instructions of the PSI protocol. However, the parties can attempt to learn as much as they can from the PSI protocol messages. This assumption fits many conventional use cases where parties are likely already under certain agreements to participate honestly. Further, it is assumed that all cryptographic primitives are secure. Finally, it is noted that the PSI protocol does reveal the sizes of the sets to both parties, as well as the final outputs in the clear (see [29] for an example of size-hiding PSI, and [47, 57] for an example of protecting the outputs).

It is assumed that each computing cluster (e.g., Spark cluster) has built-in security features that are enabled and that any big data framework implementation (e.g., Spark implementation) is free of vulnerabilities. These features can include data-at-rest encryption, access management, quota management, queue management, etc. It is further assumed that these features guarantee a locally secure computing environment at each local cluster, such that an attacker cannot gain access to a computing cluster unless authorized.

Further, it is assumed that only authorized users can issue commands to the orchestrator. It is further noted that the orchestrator could be operated by some (semi-honest) third party without impacting security.

In this threat model, the adversary can observe the network communication between different parties during execution of the protocol. It may also control some of the parties to observe data present in the storage and memory of their clusters, as well as the order of memory accesses. The semi-honest adversary model implies that participants are expected to supply correct inputs to the PSI protocol.

### B. Security Simulation

This section provides a proof of security in the so-called “simulation paradigm” that is standard in cryptography. In short, this enables proving that all attacks that can be carried by an adversary in the designed protocol can be simulated in an ideal world where parties only interact with an imaginary trusted third party Fpsi that accepts inputs from the parties, computes the intersection locally, and returns only the intersection to the parties. As the binning techniques described above self-reduces PSI, they inherit the security properties of the underlying PSI protocol π (e.g., a protocol such as KKRT that operates on the tokenized subsets). For the reduction, it is assumed that a hash function h is statistically close to a random function (alternatively, a nonprogrammable random oracle), and this proves that the PSI self-reduction is statistically secure. The protocol π_{PPSI} (where the underlying PSI instances π are instantiated with the real PSI protocols) is computationally secure. Assuming that the underlying PSI protocol π relies on DDH, then the protocol π_{PPSI} remains secure assuming DDH holds. This is the case, for instance, when the underlying PSI protocol is [41] assuming the OTs are instantiated via DDH [48].

A short summary of the simulation of the π_{PPSI} protocol in the F_{PSI} ideal world is provided. Note that the protocol operates in the semi-honest model, so the simulator has access to the input tape of the corrupt party. In addition, the protocol in the F_{PSI}-hybrid model where the protocol can call the PSI functionality F_{PSI} as a subroutine. It is noted however these calls will be on subsets of the overall data. For the sake of readability, this functionality is denoted F_{PSI}.

Since the protocol is effectively symmetric, without loss of generality, the first party P₁ is assumed to be the corrupt party. The simulator begins by feeding the input S₁ to the ideal PSI functionality F_{PSI} to obtain the PSI output I′=s₁∩s₂. Next it partitions I′ into m bins as specified by h, i.e. Iⱼ={i∈I′|h(i)=j} denotes bin j. If any bin Iⱼ has more than (1+δ₀)n/m elements, then the simulator aborts. Then for each bin j, the simulator emulating F′_{PSI}. in the hybrid world receives from P₁ a padded set of size (1+δ₀)n/m, and returns Iⱼ as the output of the call to F′_{PSI}. Finally, the simulator outputs I′. This completes the description of the simulation.

Note that the simulation fails if (1) simulator encounters binning failure (i.e., bin size exceeds (1+δ₀)n/m), or (2) dummy item added by one party matches an item from the other party. Thus from the analysis described in the Subset Assignment subsection, it can be concluded that the ideal world simulation is statistically indistinguishable from the hybrid-world protocol.

### V. PARALLEL PDJ BASED ON PARALLEL PSI

This section describes how SQL-style join queries can be performed using the PPSI techniques described above. As described above, in a private database join (PDJ) two parties may wish to perform a join operation on their private data. These parties can be assisted by an orchestrator, a computer system can that expose metadata such as data set schemas that can be used to perform the join operations.

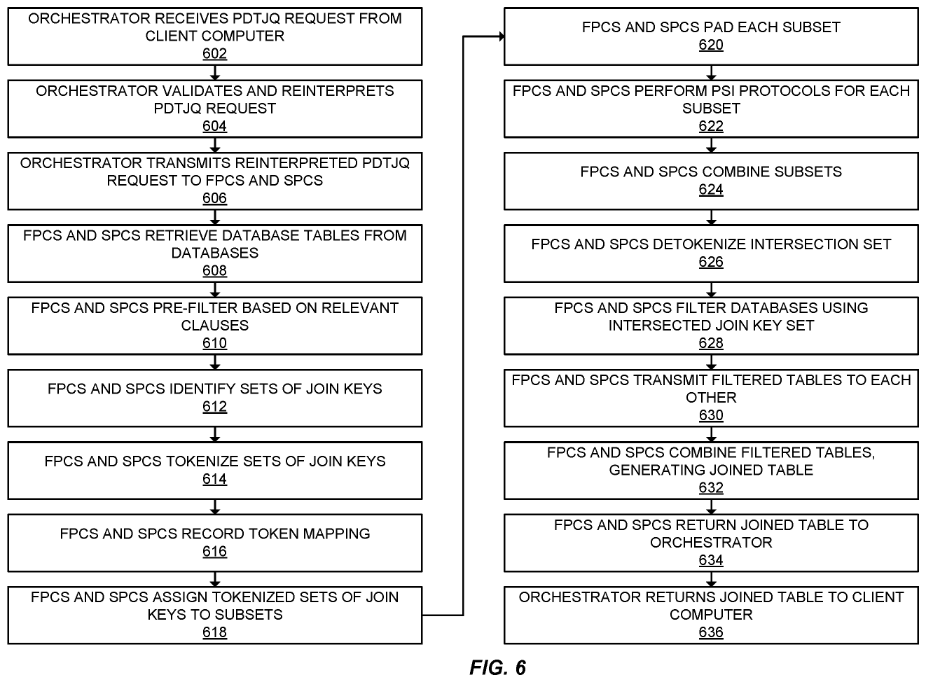

FIG. 6 shows a flowchart of an exemplary PPDJ method according to some embodiments. This PPDJ method can be used to perform a private database join based on such a query, using some of the binning and PPSI techniques described above in Sections II and III. Various steps of FIG. 6 are optional.

At step 602, an orchestrator computer can receive a request from a client computer. This request can comprise a private database table join query (PDTJQ). The client computer can comprise a computer system associated with either party or any other appropriate client (e.g., a client authorized by either party to receive the output of a PDJ). The query to perform the private database table join can be submitted to the orchestrator computer using an orchestrator API, such as a Jupyter lab interface.

At step 604, the orchestrator computer can validate the correctness of the query. This can include validating the syntax of the query, as well as validating that the PPSI and PPDJ system can perform a PDJ based on the received query. Embodiments can support any query that can be divided into the following: a “select” clause that specifies one or more columns (sometimes referred to as attributes) among the two tables, A “join on” clause that compares one or more columns for equality between the first party set and the second party set, and a “where” clause that can be split into conjunctive clauses where each conjunction is a function of a single table. Therefore, validating the correctness of the query may comprise verifying that the query contains one or more clauses from among these supported clauses.

As an example, for illustrative purposes, embodiments can support the following query:

| SELECT | P2.table0.col4 | , P1.table0.col3 |
|---|---|---|
| FROM | P1.table0 | |
| JOIN | P2.table0 | |
| ON | P1.table0.col1 | = P2.table0.col2 |
| AND | P1.table0.col2 | = P2.table0.col6 |
| WHERE | P1.table0.col3 | > 23. |

In this example a column from both parties is being selected and joined based on the equality of the join keys:
P1.table0.col1=P2.table0.col2
P1.table0.col2=P2.table0.col6
   along with the added constraint:
P1.table0.col3>23.

After validating the correctness of the private database table join query, the orchestrator can reinterpret the query, if necessary, so that it can be understood by the first party computing system and the second party computing system. This reinterpretation may involve reframe the query as a PSI, as Spark code, as one or more Spark jobs, etc.

At step 606, the first party computing system and second party computing system can receive the private database table join query (reinterpreted if necessary) from the orchestrator. The private database table join query may identify one or more first database tables and one or more second database tables (e.g., tables that can be joined), along with one or more attributes. The attributes may correspond to columns in the identified tables over which the join operation can be performed. In some embodiments, the first party computing system and second party computing system can review the reinterpreted private database table join query and approve or deny the query, prior to performing the rest of the PDJ.

At step 608, the first party computing system and the second party computing system can retrieve the one or more first database tables and one or more second database tables from a first party database and a second party database respectively.

At optional step 610, in some embodiments the private database table join query may comprise a “where” clause. In these embodiments, the first party computing system and second party computing system can pre-filter the one or more first database tables and one or more second database tables based on the “where” clause. This can comprise, for example, removing rows from the database tables for which a corresponding column fails the “where” clause. It may be possible to implement “where” clauses that are functions of multiple tables if more sophisticated underlying PSI protocols are used, for example, PSI protocols that can keep the output set in secret shared form.

At step 612, the first party computing system and second party computing system can each determine a set of join keys (alternatively referred to as a plurality of first or second party join keys, or a first party set and second party set) corresponding to the private database table join query. This set of join keys may comprise data entries corresponding to one or more columns in the one or more first and second database tables. These columns may themselves correspond to the attributes identified by the private database table join query. Thus, the first party computing system and second party computing system can determine a plurality of first party join keys and a plurality of second party join keys based on the one or more first or second database tables and the one or more attributes.

Once the local “where” clauses have been used to filtered the input tables, the first party computing system and second party computing system can treat the join key columns as the first party set and second party set, then perform the binning techniques described in Section II. The join key columns may refer to the columns that appear in the “join on” clause. In the example above these are P1.table0.col1, P1.table0.col2 for the first party and P2.table0.col2, P2.table0.col6 for the second party.

At step 614, the first party computing system and second party computing system can tokenize the plurality of first party join keys and the plurality of second party join keys respectively, thereby generating a tokenized first party join key set (comprising a plurality of first party tokens) and a tokenized second party join key set (comprising a plurality of second party tokens). Step 614 may be similar to step 412 as described in Section II.A above with reference to FIGS. 4 and 5.

In some embodiments, in which there are multiple attributes, the first party computing system can concatenate each first party join key corresponding to that attribute, thereby generating a plurality of concatenated first party join keys. The first part computing system can then hash the plurality of concatenated first party join keys to generate a plurality of hash values, which can comprise the tokenized join key set. Using the example private database table join query above, the first party can generate their tokenized join key set P1 as follows:
P1={H(P1.table0.col1[i], P1.table0.col2[i])|i∈{1, . . . , n}}

Let P2 denote the analogous set of tokens for the second party. In other words, rather than hash each join key set individually (e.g., hashing P1.table0.col1[i] and hashing P1.table0.col2[i] individually), the first party computing system can combine these join key sets via concatenation before hashing. This concatenation operation can reduce the number of PPSI operations that need to be performed, and thus can improve performance. Note that rows with the same join keys will have the same token, thus the tokenized sets P1 and P2 may contain only a single copy of that token.

At step 616, the first party computing system and second party computing system can each generate a mapping that relates their respective tokens to the original data values (e.g., the join keys). In some embodiments, this can be accomplished by appending a “token” column to the one or more first party data tables and the one or more second party database tables. The first party computing system can generate a token column comprising the tokenized first party join key set and append it to the one or more first database tables. The second party computing system can perform a similar process. That is, for the example above:
P1.table0.token=H(P1.table0.col1[i], P1.table0.col2[i])

At step 618, the first party computing system and second party computing system can assign their respective tokenized sets of join keys to tokenized first and second party subsets. The first party computing system can generate a plurality of tokenized first party subsets by assigning each first party token of the plurality of first party tokens to a tokenized first party subset of the plurality of tokenized first party subsets using an assignment function, such as the lexicographical or hash-based assignment functions described above with reference to step 414 in FIGS. 4 and 5. The second party computing system can perform a similar process.

At step 620, if necessary, the first party computing system and second party computing system can pad each of their tokenized subsets using dummy tokens, e.g., as described in Section II.C with reference to step 416 in FIGS. 4 and 5.

At step 622, for each tokenized subset of the plurality of tokenized subsets, the first party computing system and the second party computing system can perform a private set intersection protocol, thereby performing a plurality of private set intersection protocols and generating a plurality of intersected token subsets, e.g., as described in Section III with reference to step 418 in FIGS. 4 and 5. The first party computing system and second party computing system can use any appropriate PSI protocol, such as KKRT, PSSZ15, PSSW18, etc.

At step 624, the first party computing system and second party computing system can combine the plurality of intersected token subsets, thereby generating an intersected token set, e.g., as described in Section III with reference to step 420 in FIGS. 4 and 5 The first party computing system and second party computing system can use an union operation to combine the plurality of intersected token subsets.

At step 626, the first party computing system and second party computing system can detokenize the intersected token set, thereby generating an intersected join key set, e.g., as described in Section III with reference to step 422 in FIGS. 4 and 5. The first party computing system and second party computing system can accomplish this detokenization using, for example, the “token” column, generated and appended to the database tables at step 616 above.

At step 628, the first party computing system and second party computing system can filter their respective database tables using the intersected join key set, thereby generating one or more filtered first party database tables and one or more filtered second party database tables. This can involve, for example, removing one or more rows from the one or more first database tables based on the token column, the one or more rows corresponding to the one or more tokenized first party join keys that are not in the intersected join key set, and likewise for the one or more second database tables.

At step 630, the first party computing system can transmit the one or more filtered first database tables to the second party computing system. Likewise, the second party computing system can transmit the one or more filtered first database tables to the first party computing system. This transmission may enable both parties to construct the joined database table. Notably, because both tables have been filtered using the intersected join key set, they do not leak any additional information.

At step 632 the first party computing system and the second party computing system can combine the one or more filtered first database tables and the one or second filtered database tables, thereby generating a joined table. This can be accomplished using a standard (e.g., non-private) join operation between the one or more filtered first database tables and one or more filtered second database tables using the intersected join key set.

At step 634, the first party computing system and second party computing system can each transmit the joined database table to the orchestrator computer. Optionally, the orchestrator computer can confirm that the two joined database tables are equivalent, in order to verify that both the first party computing system and the second party computing system acted semi-honestly.

At step 636, the orchestrator computing system can transmit the joined database table to the client computer, via, for example, the orchestrator API described above.

In summary, the PDJ operation can be performed using a series of phases. In one phase, the PSI and PDJ system can reinterpret a PDJ query as a set intersection operation. In a subsequent phase, tables corresponding to the PDJ query can be retrieved by their respective parties (from, e.g., a first party database and a second party database). Next, the parties can determine a set of join keys based on the reinterpreted PDJ query. Using binning techniques described above, each party can produce tokenized join key subsets, the intersection of which can be determined using PPSI techniques. Afterwards, the intersection can be used to perform a “reverse token lookup,” enabling the parties to filter their respective data tables. Each party can transmit their filtered data tables to one another, then use the two filtered data tables to construct the joined data table.

### VI. SPARK-PSI

This section describes a particular implementation of an embodiment of the present disclosure using existing open source Apache software, including Apache Spark. This implementation is referred to as “SPARK-PSI” and uses a C++ implementation of the KKRT protocol as the underlying PSI protocol used in PPSI techniques described above. This section shows how embodiments of the present disclosure can be implemented in practice, using industry standard software.

### A. Apache Spark

Apache Spark is an open-source distributed computing framework used for large-scale data workloads. It utilizes in-memory caching and optimizes query execution for any size of data. On top of Spark, there are libraries for running distributed computations such as SQL queries, machine-learning algorithms, graph analytics, and data streaming. A Spark application consists of a “driver program” (operated by a “driver” or a “master” node) that translates user-provided data processing pipelines into individual tasks and distributes these tasks to “worker nodes.” The basic abstractions available in Spark are built on a distributed data structure called the “resilient distributed dataset” (RDD) [73] and these abstraction offer distributed data processing operators such as map, filter, reduce, broadcast, etc. Higher-level abstractions expose popular APIs such as SQL, streaming, and graph processing.

Implementing PSI using Apache Spark can potentially achieve performance gains, due to the demonstrated capabilities of Spark and similar data platforms. However, Spark lacks any multi-tenant concepts, and runs all applications and scheduling all tasks in one security domain. This is incompatible with the basic settings of PSI protocols, which involve two or more untrusted parties that require multiple security domains with strong isolation between them. Embodiments address this problem by assigning each party to one Spark cluster, thus achieving isolation by physically separating each party's computation. Additionally, embodiments introduce an orchestrator computers that coordinates multiple independent Spark clusters in different data centers to jointly perform the PSI tasks.

A second security issue with Apache Spark (addressed by SPARK-PSI) is the default data-partitioning scheme, which can reveal information about each party's dataset. For example, if data is partitioned to worker nodes based on the first byte in each data element, a malicious user can learn how many data elements begin with a particular byte (e.g., 0×00, 0×01, etc.). This can leak information about the data distribution in a dataset, and undermines the security associated with PSI protocols. This problem is addressed using secure binning techniques described in Section II.

Another potential issue (addressed by SPARK-PSI) is that adding an orchestrator outside of Spark clusters can lead to sub-optimal execution plans. In particular, the local optimization of schedules at each cluster may reduce performance for collaborative computing across multiple clusters with different data sizes and hardware configurations. SPARK-PSI however can take advantage of Spark's lazy evaluation capability, which can be used to delay the execution of a task until a certain action is triggered. In this way, lazy evaluation can be used to efficiently coordinate operations across clusters.

### B. SPARK-PSI System

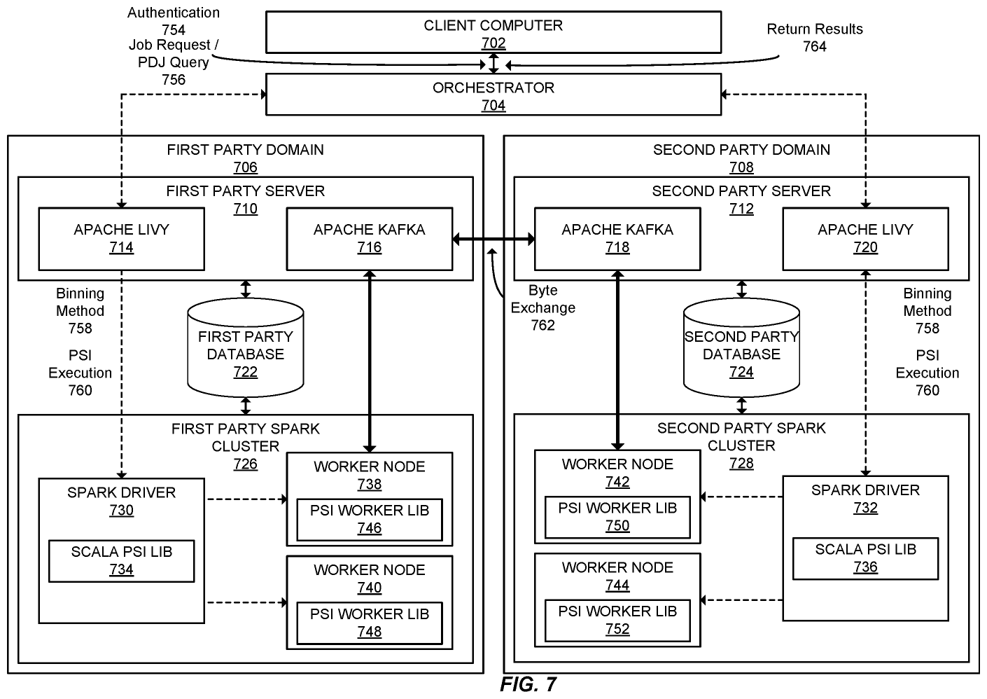

FIG. 7 shows the overall system architecture of a SPARK-PSI system. A first party and a second party can use the SPARK-PSI system to determine the PSI of a first party set and a second party set (e.g., two private datasets). Alternatively or additionally, the first party and the second party can use the SPARK-PSI system to complete a PDJ operation. In doing so, the first party and the second party can produce a joined table.

As described in Section I with reference to FIG. 2, each party can possess its own respective domain (first party domain 706 and second party domain 708) containing that party's data (e.g., sets, database tables, etc.) and computational resources. These may include a first party (edge) server 710, a first party database 722, and a first party Spark cluster 726, along with a corresponding second party (edge) server 712, a second party database 724, and a second party Spark cluster 728.

An orchestrator computer 704 can coordinate the computational resources of the first party domain 706 and the second party domain 708 in order to enable the two parties to determine a PSI or complete a PDJ. The orchestrator 704 can expose an interface (such as a UI application, a portal, a Jupyter Lab interface, etc.) that enables a client computer 702 to transmit a private database join query and receive the results of that query (e.g., a joined database table). The orchestrator 704 can interface with the first party server 710 and the second party server 712 via their respective Apache Livy [45] cluster interfaces 714 and 720. Although the orchestrator computer 704 is shown outside the first party domain 706 and the second party domain 708, in practice the orchestrator 704 can be included in either of these domains.

As stated above with reference to FIG. 2, the orchestrator 704 can store and manage various metadata, including the schemas of any datasets stored by the first party and the second party (e.g., in the first party database 722 and the second party database 724). The orchestrator computer 704 may acquire these metadata and schemas during an initialization phase performed between the orchestrator 704, the first party server 710, and the second party server 712. During this initialization phase, the first party server 710 and the second party server 712 may transmit their respective metadata and schemas to the orchestrator 704.

During a PDJ operation, a client computer 702 can first authenticate itself with the orchestrator 704 at step 754 using any appropriate authentication technique. The client computer can comprise a computer system associated with one of the two parties (e.g., the first party), or any other appropriate client. After authentication, at step 756 the client computer 702 can transmit a join request or a PDJ query (e.g., an SQL-style query) to the orchestrator 704.

The orchestrator 704 can parse the PDJ query and compile Apache Spark jobs for the first party Spark cluster 726 and the second party Spark cluster 728. These Spark jobs may correspond to actions or steps to be performed by each cluster during the PDJ operation, including steps associated with PPSI techniques described above. The orchestrator can then transmit these Spark jobs along with other relevant information, such as data set identifiers, join columns, network configurations, etc. to the first party server 710 and second party server 712 via their Apache Livy interfaces 714 and 720.

Using the Spark jobs and other relevant information, the first party server 710 and second party server 712 can retrieve any relevant database tables from the first party database 722 and second party database 724. From these database tables, the first party server 710 and second party server 712 can extract any relevant data sets (e.g., a first party set and a second party set) on which PSI operations can be performed.

At step 758, the first party server 710 and second party server 712 can perform binning techniques (described above in Section II) on the first party set and second party set. As described above, this can comprise first tokenizing these datasets, thereby producing tokenized first and second party datasets. The first party server 710 and the second party server 712 can then assign the tokenized elements to subsets (using for example, a hash-based assignment function), thereby generating a plurality of first party token subsets and a plurality of second party token subsets. Subsequently, the first party server 710 and second party server 712 can pad the token subsets with dummy values.

Afterwards, at step 760, the first party server 710 and second party server 712 can initiate PSI execution and transmit the token subsets and any relevant Spark code to the first party Spark cluster and second party Spark cluster respectively. The first party server 710 and second party server 712 can use their respective Apache Livy[45] interfaces 714 and 720 to internally manage Spark sessions and submit Spark code used for determining private set intersections. The Spark drivers 730 and 732 can interpret this Spark code and assign Spark jobs or tasks, related to PSI, to worker nodes 738-744. The worker nodes 738-744 can then execute these tasks.

Additionally, the first party server 710 and second party server 712 can use their respective Apache Kafka frameworks 716 and 718 to act as “Kafka brokers,” establishing a secure data transmission channel between the first party Spark cluster 726 and the second party Spark cluster 728. These may include one or more “byte exchanges” 762 used to perform specific steps of the underlying KKRT PSI protocol. While Apache Kafka has been chosen to implement the communication pipeline in SPARK-PSI, this architecture allows the parties to use any other appropriate communication framework to read, write, and transmit data.

### C. Advantages of SPARK-PSI Implementation Architecture

There are several advantages associated with abovementioned SPARK-PSI implementation. One such advantage is that SPARK-PSI does not require any internal changes to Apache Spark, making it easier to adopt and deploy at scale. Other advantages relate to data security. While the security of a PDJ is guaranteed by employing a secure PSI protocol, there are some other security features provided by the SPARK-PSI architecture. More concretely, in addition to the built-in security features of Apache Spark, the SPARK-PSI design ensures cluster isolation and session isolation, as described below.

The orchestrator 704 provides a protected virtual computing environment for each PSI or PDJ job, thereby guaranteeing session isolation. While standard TLS can be used to secure communications between the first party domain 706 and the second party domain 708, the orchestrator 704 can provide additional communication protection such as session specific encryption and authentication keys, randomized and anonymized endpoints, managed allow and deny lists, and monitoring and/or preventing DOS/DDOS attacks to the first party server 710 and second party server 712. As described above, the orchestrator also provides an additional layer of user authentication and authorization. All of the computing resources, including tasks, cached data, communication channels, and metadata may be protected within a session. External users can be prevented from viewing or altering the internal state of the session. The first party Spark cluster 726 and second party Spark cluster 728 may be isolated from one another, and may only report execution states to the orchestrator 704 via the first party server 710 and second party server 712.

Cluster isolation aims to protect each party's computing resources from misuses during PSI or PDJ operations. To accomplish this, the orchestrator 704 can comprise the only node in the SPARK-PSI system that has access to the end-to-end processing flows. The orchestrator 704 can also comprise the only node in the SPARK-PSI system that possesses the metadata corresponding to the first party Spark cluster 726 and second party Spark cluster 728. The orchestrator 704 can exist outside the first party domain 706 and second party domain 708 in order to remove the orchestrator 704 from accessing the dataflow pipeline between the first party cluster 726 and second party cluster 728. However, even if the orchestrator 704 is included in one party's domain, a separate secure communication channel between the first party cluster 726 and second party cluster 728 is employed via Apache Livy and Kafka, which prevents each party from accessing the other Spark cluster, thus the orchestrator 704 is still removed from the data flow pipeline. This secure communication channel also ensures that each Spark cluster is self-autonomous and requires little or no changes to participate in a database join protocol with other parties. The orchestrator 404 can also manage join failures and uneven computing speeds to ensure out-of-the box reusability of the first party Spark cluster 726 and the second party Spark cluster 728.

Further, the low level APIs that call cryptographic libraries and exchange data between C++ instances and Spark data frames (e.g., Scala PSI libraries 734 and 736, and PSI worker libraries 746-752) are located in the first party Spark cluster 726 and the second party Spark cluster 728, and thus do not introduce any information leakage. High level APIs can package the secure Spark execution pipeline as a service and can map independent jobs to each worker node 738-744 and collect the results from the worker nodes.

In summary, the SPARK-PSI architecture provides the theoretical security associated with the underlying PSI protocol (e.g., KKRT). In other words, if one party is compromised by a hacker or other malicious user, the other party's data remains private, except for what is revealed by the output of the PSI or PDJ operation.

### D. Spark PSI Implementation Workflow

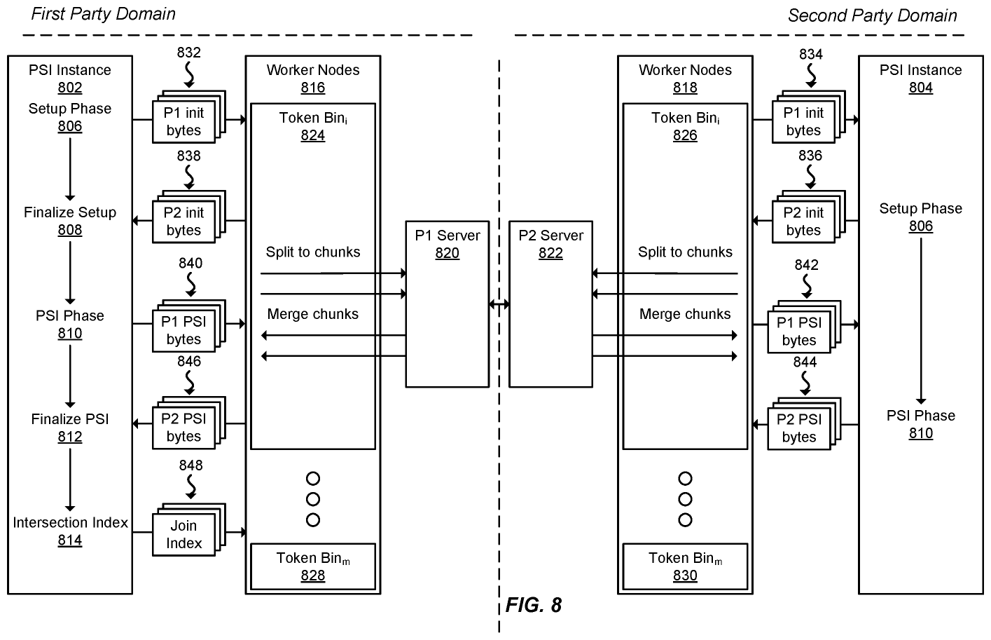

FIG. 8 shows a detailed data workflow in the SPARK-PSI framework instantiated with the KKRT protocol. The phases in each PSI instance 802 and 804 can be invoked by an orchestrator computer sequentially. The orchestrator can start the KKRT execution by submitting metadata information about the first party set and the second party set to both parties.

In the setup phase 806 (including steps 832-838), based on the request, the first party computing system (comprising a first party server 820 and a Spark cluster comprising worker nodes 816) and the second party computing system (comprising a second party server 822 and a Spark cluster comprising worker nodes 818) can start executing their respective

Spark code. This code can create new data frames by loading the first party set and the second party set using supported Java Database Connectivity (JDBC) drivers. As described above with reference to Section II, these data frames can then be hashed to produce token data frames. The token data frame can then be mapped to m token bins or subsets. Using Apache Spark terminology, these bins may be referred to as “partitions.” Shown in FIG. 8 are four such bins, first party token bin, 824, first party token binm 828, second party token bin, 826, and second party token binm 830. If necessary, these bins can be padded with dummy tokens. The token bins can be distributed to the worker nodes 816 and 818, enabling parallel KKRT execution.

After finalizing the setup, the PSI instances 802 and 804 can enter the PSI phase 810. In this phase, the native KKRT protocol can be executed via a generic Java Native Interface (JNI) that connects to the Spark code. The JNI can operate in terms of round functions, and therefore can operate regardless of the particular implementation of the KKRT PSI protocol. Note the KKRT protocol has a one-time setup phase, which is required only once for a given pair of parties. This setup phase corresponds to steps 832-838. Refer to [41] for more details on the setup phase. The online PSI phase (which can determining the intersection between the token bins) corresponds to steps 840-848. The two parties can use the first party server 820 and second party server 822 to mirror data whenever there is a write operation on any of the Kafka brokers.

Note that the main PSI phase includes sending encrypted token datasets and can be a performance bottleneck for Apache Kafka, which is optimized for small messages. To overcome this issue, the worker nodes 816 and 818 can split encrypted datasets into smaller data chunks before transmitting them to the other party via first party server 820 and second party server 822. When receiving data from the other party via first party server 820 and second party server 822, the worker nodes 816 and 818 can merge the chunks, reproducing the encrypted token datasets and allowing them to perform the KKRT PSI protocol. Additionally, intermediate data retention periods can be kept short on the Kafka brokers to overcome storage and security concerns.

Data chunking has the additional benefit of enabling streaming of underlying PSI protocol messages. Note that the native KKRT implementation is designed to send and receive data as soon as it is generated. As such, the SPARK-PSI implementation can continually forward the protocol messages to and from Kafka the moment they become available. This effectively results in additional parallelization due to the worker nodes 816 and 818 not needing to block for slow network I/O. Note that this implementation can caches the token data frame and instance address data frame which are used in multiple phases to avoid any re-computation. In this way, the SPARK-PSI implementation can take advantage of Spark's lazy evaluation, which optimizes execution based on directed acyclic graph (DAG) and resilient distributed dataset (RDD) persistence.

### E. Reusable Components

The SPARK-PSI implementation has several components that can be reused to parallelize PSI protocols other than KKRT. Code corresponding to the SPARK-PSI implementation can be packaged as a Spark-Scala library which includes an end-to-end example implementation of the native KKRT protocol. This library itself has several reusable components, such as JDBC connectors to work with multiple data sources, methods for tokenization and subset assignment, general C++ interfaces to link other native PSI algorithms, and a generic JNI between Scala and C++. Each of these functions can be implemented in a base class of the library, which may be reused for other native PSI implementations. Additionally, the library can decouple networking methods from actual PSI determination. This can add flexibility to the framework, enabling the use of other networking channels if required.

Most PSI protocols can be “plugged into” SPARK-PSI by exposing a C/C++ API that can be invoked by the framework. The API is structured around the concept of setup rounds and online rounds, and thus does not make any assumptions about the cryptographic protocol executed in these rounds. The API can include the following functions:
Get-setup-round-count ()->count: retrieves the total number of setup rounds required by this PSI implementation.

Setup (id, in-data)->out-data: invokes round id on the appropriate party with data received from the other party in the previous round of the setup and returns the data to be sent.

Get-online-round-count ()->count: retrieves the total number of online rounds required by this PSI implementation.

Psi-round (round id, in-data)->out-data: invokes the online round id on the appropriate party with data received from the other party in the previous round of the PSI protocol and returns the data to be sent.

The data passed to an invocation of psi-round can comprise the data from a single tokenized subset, and SPARK-PSI can orchestrate the parallel invocations of this API over all the bins. As an example, for a KKRT implementation, there are three setup rounds (labelled P1.setup1, P2.setup1, and P1.setup2) and three online rounds (labeled P1.psi1, P2.psi1, and P1.psi2). When running KKRT with 256 bins, the setup rounds P1.setup1, P2.setup1, and P1.setup2 can each invoke setup once with the appropriate round id, and the online rounds P1.psil, P2.psi1, and P1.psi2 can each invoke psi-round with the appropriate round id 256 times.

### VII. EXPERIMENTAL EVALUATION

This section describes the results of PSI experiments performed using a SPARK-PSI system. Additionally, this section provides benchmarks for various steps in a PSI protocol (e.g., tokenization, setup rounds, etc.). This section further provides end-to-end performance results and details the impact of the number of bins on the running time. Notably, a running time of 82.88 minutes was achieved when performing PSI on sets comprising one billion elements. This result was achieved using 2048 bins, and corresponds to a value δ0=0.019 for a bin size of approximately 500,000.

These experiments were evaluated on a SPARK-PSI setup similar to the one described in FIGS. 7 and 8. In the experiment, a first party and a second party performed a KKRT-based PPSI protocol using the SPARK-PSI system. Each party ran an independent standalone six-node Spark (v2.4.5) cluster with one driver server and five worker servers. Additionally, each party operated an independent Kafka (v2.12-2.5.0) VM (acting as an edge server) for inter-cluster communication. The orchestrator server, which triggers the PSI computation, was in the first party domain. All servers had 8 vCPUs (2.6 GHz), 64 GB RAM and ran Ubuntu 18.04.4 LTS.

Table 1 summarizes the amount of time required to perform various steps in a KKRT-based PPSI method for different dataset sizes (i.e., 10 million, 50 million, and 100 million elements) using 2048 bins (tokenized subsets). P1.tokenize denotes the amount of time taken to perform binning techniques, i.e., tokenize the first party set, map those tokens to different tokenized subsets, and pad each tokenized subset. The tokenization step was performed by the worker nodes in parallel.

P1.psi1 denotes the amount of time taken to transmit a set of PSI bytes corresponding to the first party (i.e., at step 540 in FIG. 8). In this step, the first party computing system generates and transfers approximately 60 n bytes of data (where n is the number of elements in the dataset) to the second party computing system via the first party (edge) server. Likewise, P2.psi1 denotes the amount of the time taken to receive a set of PSI bytes corresponding to the second party (e.g., at step 546 in FIG. 8) for each tokenized subset. In this step, the second party computing system generates and transfers approximately 22 n bytes of data back to the first party computing system via the second party (edge) server. P1.psi2 denotes the amount of time taken to receive a set of PSI bytes corresponding to the tokenized intersection subsets, combine the tokenized intersection subsets, and detokenize the tokenized intersection set, thereby producing the intersection set.

TABLE 1
Microbenchmark of SPARK-PSI using
KKRT PSI and 2048 bins.

| Spark-PSI | Time (s) by dataset size | | |
|---|---|---|---|
| Step | 10M | 50M | 100M |
| P1.tokenize | 47.21 | 91.20 | 124.88 |
| P2.tokenize | 45.90 | 92.89 | 121.64 |
| P1.psi1 | 8.40 | 20.64 | 31.55 |
| P2.psi1 | 40.83 | 121.73 | 247.30 |
| P1.psi2 | 14.92 | 47.49 | 88.05 |

Table 2 shows the impact of bin size on the time taken to perform inter-cluster communication, including reading and writing data via a data stream processor (Such as Apache Kafka). The P1.psi1 step produces 9.1 GB of intermediate data that is sent to the second party computing system via the first party (edge) server. The P2.psi1 steps produces 3.03 GB of intermediate data that is sent to the first party computing system via the second party (edge) server. As evident from the benchmarks in Table 2, using more bins improves networking performance as the message chunks become smaller. In more detail, when 256 bins are used, individual messages of size 35.55 MB are sent via the data stream processor during the P1.psi1 step. When 2048 bins are used, the corresponding individual message size is only 4.44 MB.

TABLE 2
Network latency for datasets comprising
100 million elements.

| KKRT PSI | Time (s) by number of bins | |
|---|---|---|
| round | 256 | 2048 |
| P1.psi1.write | 36.44 | 13.36 |
| P2.psil.read | 178.76 | 98.77 |
| P2.psi1.write | 15.24 | 8.12 |
| P1.psi2.read | 25.61 | 21.35 |

Table 3 compares the performance of SPARK-PSI with the performance of insecure joins on datasets comprising 100 million elements. To evaluate and compare the performance of SPARK-PSI with the performance of insecure joins, two insecure join variants are considered. In the first variant, referred to as a “single-cluster Spark join,” a single computing cluster with six nodes (one driver nodes and five worker nodes) is used to perform the join on two datasets each comprising 100 million elements. The join computation is performed by partitioning the data into multiple bins and determining the intersection directly using a single Spark join call.

In the second variant, referred to as a “cross-cluster Spark join,” two computing clusters each comprising six node (one driver node and five worker nodes) are used, each cluster containing a 100 million element tokenized dataset. To perform the join, each cluster partitions its dataset into multiple bins. Then one of the clusters sends the partitioned dataset to the other cluster, which then aggregates the received data into one dataset, and then computed the final join using a single Spark join call.

For the insecure single cluster join, increasing the number of bins leads to an increase in the number of data shuffling operations (e.g., shuffle read/write operations), which reduces the execution speed. When the insecure join is split across two clusters, there is additional network communication overhead and additional shuffling operations on the destination cluster, but an increase in parallelism because the two cluster system has twice the compute resources.

When using SPARK-PSI, the cross-cluster communication overhead is maintained and the PSI computation incurs additional overhead, but the extra data shuffling is avoided (as the system employs broadcast join). The effect of the broadcast join increases when the system uses a larger number of bins (e.g., 8,192 bins) making SPARK-PSI faster than the insecure cross-cluster join in some cases. The system introduces an overhead of up to 77% in the worst case, when compared to the insecure cross-cluster join.

TABLE 3
Total execution time for different joins over 100
million element datasets.The fastest times in each
column are bolded.

| | Time (m) | | |
|---|---|---|---|
| Number | Insecure single- | Insecure cross-cluster | Spark- |
| of bins | cluster Spark join | Spark join | PSI |
| 256 | 3.76 | 7.60 | 11.41 |
| 4096 | 5.62 | 4.90 | 8.71 |
| 8192 | 10.83 | 10.26 | 9.79 |

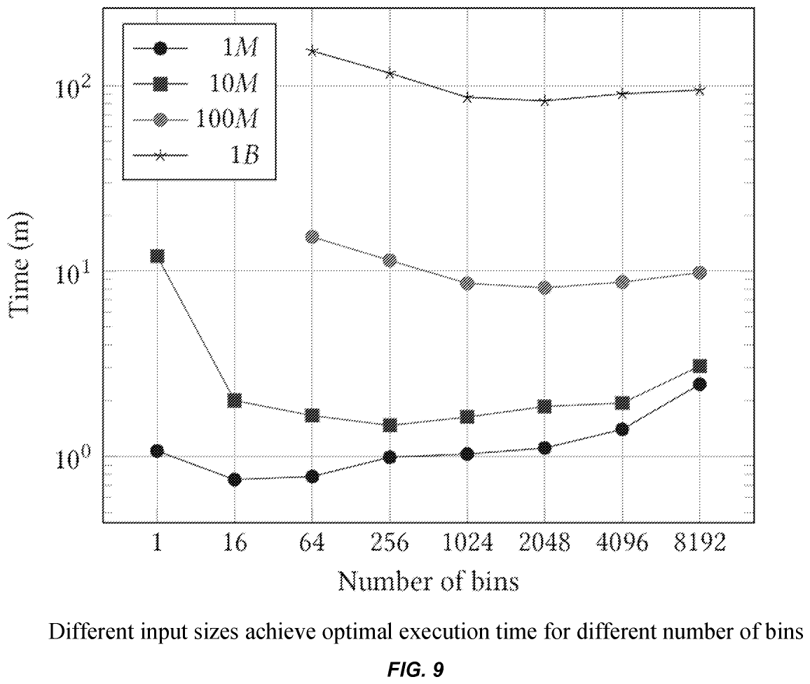

Table 4 details running times associated with SPARK-PSI as a function of the number of bins and dataset size. The running times are also plotted in FIG. 9. One notable result is the running time of 82.88 minutes for a dataset comprising one billion elements and using 2048 bins, roughly 25 times faster than the prior work of Pinkas et al. [60]. Also as indicated by Table 4 and from the corresponding plot in FIG. 9, SPARK-PSI performance improves as the number of bins increases, then hits an inflection point after which performance degrades. The initial improvement is a result of parallelization. Higher number of bins results in smaller bin size on Spark, which is preferable for larger datasets. However as the number of bins increases further, the task scheduling overhead in Spark (and the padding overhead of various binning techniques) slows down the execution. Better performance may be possible if more worker nodes are used, as this is likely to allow better parallelization.

TABLE 4
Total execution time for SPARK-PSI with
various dataset sizes and bin sizes.
The fastest times in each column are bolded.

| Number | Time (m) by dataset size | | | |
|---|---|---|---|---|
| of bins | 1M | 10M | 100M | 1B |
| 1 | 1.07 | 12.04 | — | — |
| 16 | 0.75 | 2.00 | — | — |
| 64 | 0.78 | 1.66 | 15.27 | 154.10 |
| 256 | 0.99 | 1.47 | 11.41 | 116.89 |
| 1,024 | 1.03 | 1.63 | 8.57 | 86.54 |
| 2,048 | 1.11 | 1.86 | 8.12 | 82.88 |
| 4,096 | 1.40 | 1.94 | 8.71 | 90.46 |
| 8,192 | 2.45 | 3.07 | 9.79 | 94.74 |

### VIII. RELATED WORK AND CONCLUSIONS

Several protocols have been proposed to realize PSI such as the efficient but insecure naive hashing solution, public key cryptography based protocols [4, 12, 18, 25, 26, 29, 37, 46, 64], those based on oblivious transfer [11, 23, 41, 54, 55, 58] and other circuit-based solutions [7, 36, 56, 57]. Another popular model for PSI is to introduce a semi-trusted third party that aids in efficiently computing the intersection [1, 2, 67]. Refer to for a more detailed overview on the various approaches taken to solve PSI. In addition, other variants of PSI have also been extensively studied such as multi-party PSI [35, 42], PSI cardinality [13, 39], PSI sum [38, 39], threshold PSI [5, 27], to name a few. Apart from PSI, there is also a line of work on performing other set operations such as union privately [8, 17, 43].

Modern big data systems have demonstrated high scalability and performance since the introduction of the MapReduce programming model [20]. This introduces both opportunities and challenges alike for secure distributed computing over massive data sets and cloud computing.

Dong et al. introduce garbled Bloom filters to design an efficient PSI protocol over big data, which is implemented using the MapReduce framework. PSJoin [22] makes use of differential privacy to build a MapReduce-based privacy-preserving similarity join. Hahn et al. use searchable encryption and key-policy attribute-based encryption to design a protocol for secure joins that leak the fine granular access pattern and frequency of elements selected for the join.

SMCQL [6] uses the garbled-circuit based backend ObliVM [44] to compute query results over the union of several source databases without revealing sensitive information about individual tuples. Although optimized, it introduces prohibitive overhead. ConClave builds a secure query compiler based on ShareMind [9] and Obliv-C [75] to improve scalability. ConClave works in the server-aided model in order to decrease computational overhead. However, these systems still leave much to be desired in terms of performing efficient secure computation over big data. Furthermore, existing works are tailor-made to meet specific requirements and hence do not offer the same performance gains for arbitrary secure computation.

Another set of privacy-preserving frameworks makes use of hardware enclaves. Opaque [76] is an oblivious distributed data analytics platform which utilized Intel SGX hardware enclaves to provide strong security guarantees. OCQ [16] further decreases communication and computation costs of Opaque via an oblivious planner. Unlike these methods, SPARK-PSI does not depend on hardware. Other recent works include CryptDB [61] and Seabed [52] which provide protocols for the secure execution of analytical queries over encrypted big data. Senate [66] describes a framework for enabling privacy preserving database queries in a multiparty setting.

In conclusion, this disclosure describes the analysis and application of methods that can be used to parallelize any PSI protocol, thereby greatly improving the rate at which PSIs can be determined. Using methods according to embodiments, this disclosure demonstrates that private set intersections for large (e.g., billion element) data sets, can be determined at significantly greater speeds. Additionally, this disclosure describes a Spark framework and architecture to implement these methods in a PDJ application. The experiments show that this framework is well-suited for real-world scenarios. Additionally, this framework provides reusable components that enable cryptographers to scale novel PSI protocols to billion element sets.

### IX. COMPUTER SYSTEM

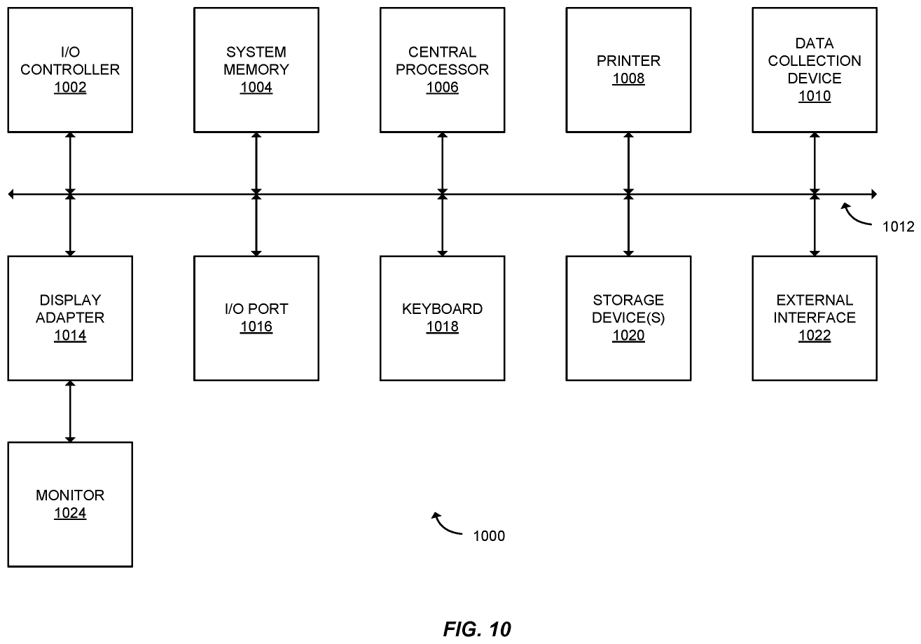

Any of the computer systems mentioned herein may utilize any suitable number of subsystems. Examples of such subsystems are shown in FIG. 10 in computer system 1000. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 10 are interconnected via a system bus 1012. Additional subsystems such as a printer 1008, keyboard 1018, storage device(s) 1020, monitor 1024 (e.g., a display screen, such as an LED), which is coupled to display adapter 1014, and others are shown. Peripherals and input/output (I/O) devices, which couple to I/O controller 1002, can be connected to the computer system by any number of means known in the art such as input/output (I/O) port 1016 (e.g., USB, FireWire®). For example, I/O port 1016 or external interface 1022 (e.g. Ethernet, Wi-Fi, etc.) can be used to connect computer system 1000 to a wide area network such as the Internet, a mouse input device, or a scanner. The interconnection via system bus 1012 allows the central processor 1006 to communicate with each subsystem and to control the execution of a plurality of instructions from system memory 1004 or the storage device(s) 1020 (e.g., a fixed disk, such as a hard drive, or optical disk), as well as the exchange of information between subsystems. The system memory 1004 and/or the storage device(s) 1020 may embody a computer readable medium. Another subsystem is a data collection device 1010, such as a camera, microphone, accelerometer, and the like. Any of the data mentioned herein can be output from one component to another component and can be output to the user.

A computer system can include a plurality of the same components or subsystems, e.g., connected together by external interface 1022, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

### X. REFERENCES

[1] Aydin Abadi, Sotirios Terzis, and Changyu Dong. 2015. O-PSI: Delegated Private Set Intersection on Outsourced Datasets. In ICT Systems Security and Privacy Protection—30th IFIP TC 11 International Conference, SEC 2015, Hamburg, Germany, May 26-28, 2015, Proceedings (IFIP Advances in Information and Communication Technology, Vol. 455), Hannes Federrath and Dieter Gollmann (Eds.). Springer, 3-17. https://doi.org/10.1007/978-3-319-18467-8_1
[2] Aydin Abadi, Sotirios Terzis, and Changyu Dong. 2016. VD-PSI: Verifiable Delegated Private Set Intersection on Outsourced Private Datasets. In Financial Cryptography and Data Security—20th International Conference, FC 2016, Christ

Church, Barbados, February 22-26, 2016, Revised Selected Papers (Lecture Notes in Computer Science, Vol. 9603), Jens Grossklags and Bart Preneel (Eds.). Springer, 149-168. https://doi.org/10.1007/978-3-662-54970-4_9
[3] Thomas Schneider N. Asokan Benny Pinkas Agnes Kiss, Jian Liu. 2017. Private Set Intersection for Unequal Set Sizes with Mobile Applications. In Proc. Priv. Enhancing Technol. (4). 177-197.
[4] Giuseppe Ateniese, Emiliano De Cristofaro, and Gene Tsudik. 2011. (If) Size Matters: Size-Hiding Private Set Intersection. In Public Key Cryptography—PKC 2011 14th International Conference on Practice and Theory in Public Key Cryptography, Taormina, Italy, March 6-9, 2011. Proceedings (Lecture Notes in Computer Science, Vol. 6571), Dario Catalano, Nelly Fazio, Rosario Gennaro, and Antonio Nicolosi (Eds.). Springer, 156-173. https://doi.org/10.1007/978-3-642-19379-8_10
[5] Saikrishna Badrinarayanan, Peihan Miao, and Peter Rindal. 2020. Multi-Party Threshold Private Set Intersection with Sublinear Communication. IACR Cryptol. ePrint Arch. 2020 (2020), 600. https://eprintiacr.org/2020/600
[6] Johes Bater, Gregory Elliott, Craig Eggen, Satyender Goel, Abel Kho, and Jennie Rogers. 2017. SMCQL: secure querying for federated databases. Proceedings of the VLDB Endowment 10,6 (2017), 673-684.
[7] Oleksandr Tkachenko Avishay Yanai Benny Pinkas, Thomas Schneider. 2019. Efficient Circuit-Based PSI with Linear Communication. In Eurocrypt 3.122-153.
[8] Marina Blanton and Everaldo Aguiar. 2016. Private and oblivious set and multiset operations. Int. J. Inf. Sec. 15,5 (2016), 493-518. https://doi.org/10.1007/s10207-015-0301-1
[9] Dan Bogdanov, Sven Laur, and Jan Willemson. 2008. Sharemind: A framework for fast privacy-preserving computations. In European Symposium on Research in Computer Security. Springer, 192-206.
[10] Justin Brickell, Donald E Porter, Vitaly Shmatikov, and Emmett Witchel. 2007. Privacy-preserving remote diagnostics. In CCS.
[11] Melissa Chase and Peihan Miao. 2020. Private Set Intersection in the Internet Setting from Lightweight Oblivious PRF. In Advances in Cryptology—CRYPTO 2020 40th Annual International Cryptology Conference, CRYPTO 2020, Santa Barbara CA, USA, August 17-21, 2020, Proceedings, Part III (Lecture Notes in Computer Science, Vol. 12172), Daniele Micciancio and Thomas Ristenpart (Eds.). Springer, 34-63. https://doi.org/10.1007/978-3-030-56877-1_2
[12] Hao Chen, Kim Lathe, and Peter Rindal. 2017. Fast Private Set Intersection from Homomorphic Encryption. In Proceedings of the 2017 ACM SIGSAC Conference on Computer and Communications Security, CCS 2017, Dallas, TX, USA, October 30-November 03, 2017, Bhavani M. Thuraisingham, David Evans, Tal Malkin, and Dongyan Xu (Eds.). ACM, 1243-1255. https://doi.org/10.1145/3133956.3134061
[13] Emiliano De Cristofaro, Paolo Gasti, and Gene Tsudik. 2012. Fast and Private Computation of Cardinality of Set Intersection and Union. In Cryptology and Network Security, 11th International Conference, CANS 2012, Darmstadt, Germany, December 12-14, 2012. Proceedings, Josef Pieprzyk, Ahmad-Reza Sadeghi, and Mark Manulis (Eds.), Vol. 7712. Springer, 218-231. https://doi.org/10.1007/978-3-642-35404-5_17
[14] Emiliano De Cristofaro, Jihye Kim, and Gene Tsudik. 2010. Linear-Complexity Private Set Intersection Protocols Secure in Malicious Model. In Advances in Cryptology—ASIACRYPT 2010—16th International Conference on the Theory and Application of Cryptology and Information Security, Singapore, December 5-9, 2010. Proceedings (Lecture Notes in Computer Science, Vol. 6477), Masayuki Abe (Ed.). Springer, 213-231. https://doi.org/10.1007/978-3-642-17373-8_13
[15] Thomas Schneider Matthias Senker Christian Weinert Daniel Kales, Chris- tian Rechberger. 2019. Mobile Private Contact Discovery at Scale. In USENIX Annual Technical Conference. 1447-1464.
[16] Ankur Dave, Chester Leung, Raluca Ada Popa, Joseph E Gonzalez, and Ion Stoica. 2020. Oblivious coopetitive analytics using hardware enclaves. In Proceedings of the Fifteenth European Conference on Computer Systems. 1-17.
[17] Alex Davidson and Carlos Cid. 2017. An Efficient Toolkit for Computing Private Set Operations. In Information Security and Privacy—22nd Australasian Conference, ACISP 2017, Auckland, New Zealand, July 3-5, 2017, Proceedings, Part II (Lecture Notes in Computer Science, Vol. 10343), Josef Pieprzyk and Suriadi (Eds.). Springer, 261-278. https://doi.org/10.1007/978-3-319-59870-3_15
[18] Emiliano De Cristofaro and Gene Tsudik. 2010. Practical private set intersection protocols with linear complexity. In FC.
[19] Jeffrey Dean and Sanjay Ghemawat. 2004. MapReduce: Simplified Data Processing on Large Clusters. In OSDI′04: Sixth Symposium on Operating System Design and Implementation. San Francisco, CA, 137-150.
[20] Jeffrey Dean and Sanjay Ghemawat. 2008. MapReduce: simplified data processing on large clusters. Commun. ACM 51, 1 (2008), 107-113.
[21] Daniel Demmler, Peter Rindal, Mike Rosulek, and Ni Trieu. 2018. PIR-PSI: Scaling Private Contact Discovery. Proc. Priv. Enhancing Technol. 2018, 4 (2018), 159-178. https://doi.org/10.1515/popets-2018-0037
[22] Xiaofeng Ding, Wanlu Yang, Kim-Kwang Raymond Choo, Xiaoli Wang, and Hai Jin. 2019. Privacy preserving similarity joins using MapReduce. Inf. Sci. 493 (2019), 20-33. https://doi.org/10.1016/j.ins.2019.03.035
[23] Changyu Dong, Liqun Chen, and Zikai Wen. 2013. When private set intersection meets big data: an efficient and scalable protocol. In Proceedings of the 2013 ACM SIGSAC conference on Computer & communications security. 789-800.
[24] Brett Hemenway Falk, Daniel Noble, and Rafail Ostrovsky. 2019. Private Set Intersection with Linear Communication from General Assumptions. In Proceedings of the 18th ACM Workshop on Privacy in the Electronic Society, WPES@CCS 2019, London, UK, November 11, 2019, Lorenzo Cavallaro, Johannes Kinder, and Josep Domingo-Ferrer (Eds.). ACM, 14-25. https://doi.org/10.1145/3338498.3358645
[25] Michael J. Freedman, Carmit Hazay, Kobbi Nissim, and Benny Pinkas. 2016. Efficient Set Intersection with Simulation-Based Security. J. Cryptology 29, 1 (2016), 115-155. https://doi.org/10.1007/s00145-014-9190-0
[26] Michael J. Freedman, Kobbi Nissim, and Benny Pinkas. 2004. Efficient private matching and set intersection. In EUROCRYPT.
[27] Satrajit Ghosh and Mark Simkin. 2019. The Communication Complexity of Threshold Private Set Intersection. In Advances in Cryptology—CRYPTO 2019—39th Annual International Cryptology Conference, Santa Barbara, CA, USA, August 18-22, 2019, Proceedings, Part II (Lecture Notes in Computer Science, Vol. 11693), Alexandra Boldyreva and Daniele Micciancio (Eds.). Springer, 3-29. https://doi.org/10.1007/978-3-030-26951-7_1
[28] Thomas Schneider Michael Zohner Gilad Asharov, Yehuda Lindell. 2013. More efficient oblivious transfer and extensions for faster secure computation. In CCS. 535-548.
[29] Gene Tsudik Giuseppe Ateniese, Emiliano De Cristofaro. 2011. (if) size matters: Size-hiding private set intersection. In PKC. 156-173.
[30] Florian Hahn, Nicolas Loza, and Florian Kerschbaum. 2019. Joins Over Encrypted Data with Fine Granular Security. In 35th IEEE International Conference on Data Engineering, ICDE 2019, Macao, China, April 8-11, 2019. IEEE, 674-685. https://doi.org/10.1109/ICDE.2019.00066
[31] Per A. Hallgren, Claudio Orlandi, and Andrei Sabelfeld. 2017. PrivatePool: Privacy-Preserving Ridesharing. In CSF.
[32] Kim Laine Hao Chen and Peter Rindal. 2017. Fast Private Set Intersection from Homomorphic Encryption. In CCS. 1243-1255.
[33] Kim Laine Hao Chen, Zhicong Huang and Peter Rindal. 2018. Labeled PSI from Fully Homomorphic Encryption with Malicious Security. In CCS. 1223-1237.
[34] Carmit Hazay and Kobbi Nissim. 2010. Efficient Set Operations in the Presence of Malicious Adversaries. In PKC.
[35] Carmit Hazay and Muthuramakrishnan Venkitasubramaniam. 2017. Scalable Multi-party Private Set-Intersection. In PKC, Serge Fehr (Ed.).
[36] Yan Huang, David Evans, Jonathan Katz, and Lior Malka. 2011. Faster Secure Two-Party Computation Using Garbled Circuits. In 20th USENIX Security Symposium, San Francisco, CA, USA, August 8-12, 2011, Proceedings. USENIX Association. http://static.usenix.org/events/sec11/tech/full_papers/Huang.pdf
[37] Bernardo A. Huberman, Matthew K. Franklin, and Tad Hogg. 1999. Enhancing privacy and trust in electronic communities. In Proceedings of the First ACM Conference on Electronic Commerce (EC-99), Denver, CO, USA, November 3-5, 1999, Stuart I. Feldman and Michael P. Wellman (Eds.). ACM, 78-86. https://doi.org/10.1145/336992.337012
[38] Mihaela Ion, Ben Kreuter, Ahmet Erhan Nergiz, Sarvar Patel, Mariana Raykova, Shobhit Saxena, Karn Seth, David Shanahan, and Moti Yung. 2019. On Deploying Secure Computing Commercially: Private Intersection-Sum Protocols and their Business Applications. IACR Cryptol. ePrint Arch. 2019 (2019), 723. https://eprint.iacr.org/2019/723
[39] Mihaela Ion, Ben Kreuter, Erhan Nergiz, Sarvar Patel, Shobhit Saxena, Karn Seth, David Shanahan, and Moti Yung. 2017. Private Intersection-Sum Protocol with Applications to Attributing Aggregate Ad Conversions. (2017). ia.cr/2017/735.
[40] Lea Kissner and Dawn Song. 2005. Privacy-preserving set operations. In CRYPTO.
[41] Vladimir Kolesnikov, Ranjit Kumaresan, Mike Rosulek, and Ni Trieu. 2016. Efficient batched oblivious PRF with applications to private set intersection. In Proceedings of the 2016 ACM SIGSAC Conference on Computer and Communications Security. 818-829.
[42] Vladimir Kolesnikov, Naor Matania, Benny Pinkas, Mike Rosulek, and Ni Trieu. 2017. Practical Multi-party Private Set Intersection from Symmetric-Key Techniques. In CCS.
[43] Vladimir Kolesnikov, Mike Rosulek, Ni Trieu, and Xiao Wang. 2019. Scalable Private Set Union from Symmetric-Key Techniques. In Advances in Cryptology—ASIACRYPT 2019—25th International Conference on the Theory and Application of Cryptology and Information Security, Kobe, Japan, December 8-12, 2019, Proceedings, Part II (Lecture Notes in Computer Science, Vol. 11922), Steven D. Galbraith and Shiho Moriai (Eds.). Springer, 636-666. https://doi.org/10.1007/978-3-030-34621-8_23
[44] Chang Liu, Xiao Shaun Wang, Kartik Nayak, Yan Huang, and Elaine Shi. 2015. Oblivm: A programming framework for secure computation. In 2015 IEEE Symposium on Security and Privacy. IEEE, 359-376.
[45] Apache Livy. 2017. Apache Livy. https://livy.apache.org/
[46] Catherine A. Meadows. 1986. A More Efficient Cryptographic Matchmaking Protocol for Use in the Absence of a Continuously Available Third Party. In Proceedings of the 1986 IEEE Symposium on Security and Privacy, Oakland, California, USA, April 7-9, 1986. IEEE Computer Society, 134-137. https://doi.org/10.1109/SP.1986.10022
[47] Claudio Orlandi Michele Ciampi. 2018. Combining Private Set-Intersection with Secure Two-Party Computation. In SCN. 464-482.
[48] Benny Pinkas Moni Naor. 2001. Efficient Oblivious Transfer Protocols. In SODA. 448-457.
[49] Shishir Nagaraja, Prateek Mittal, Chi-Yao Hong, Matthew Caesar, and Nikita Borisov. 2010. BotGrep: Finding P2P Bots with Structured Graph Analysis. In USENIX security symposium.
[50] Arvind Narayanan, Narendran Thiagarajan, Mugdha Lakhani, Michael Ham-burg, and Dan Boneh. 2011. Location Privacy via Private Proximity Testing. In Proceedings of the Network and Distributed System Security Symposium, NDSS 2011, San Diego, California, USA, 6th February-9th February 2011. The Internet Society. https://www.ndss-symposium.org/ndss2011/privacy-private-proximity-testing-paper
[51] Michele Orrù, Emmanuela Orsini, and Peter Scholl. 2016. Actively Secure 1-out-of-N OT Extension with Application to Private Set Intersection. In CT-RSA.
[52] Antonis Papadimitriou, Ranjita Bhagwan, Nishanth Chandran, Ramachandran Ramjee, Andreas Haeberlen, Harmeet Singh, Abhishek Modi, and Saikrishna Badrinarayanan. 2016. Big data analytics over encrypted datasets with seabed. In 12th USENIX Symposium on Operating Systems Design and Implementation (OSDI 16). 587-602.
[53] Phillipp Schoppmann Peter Rindal. [n.d.]. VOLE-PSI: Fast OPRF and Circuit-PSI from Vector-OLE. In Eurocrypt.
[54] Benny Pinkas, Mike Rosulek, Ni Trieu, and Avishay Yanai. 2019. Spot-light: Lightweight private set intersection from sparse OT extension. In CRYPTO.
[55] Benny Pinkas, Mike Rosulek, Ni Trieu, and Avishay Yanai. 2020. PSI from PaXoS: Fast, Malicious Private Set Intersection. In EUROCRYPT, Anne Canteaut and Yuval Ishai (Eds.).
[56] Benny Pinkas, Thomas Schneider, Gil Segev, and Michael Zohner. 2015. Phasing: Private Set Intersection Using Permutation-based Hashing. In USENIX.
[57] Benny Pinkas, Thomas Schneider, Christian Weinert, and Udi Wieder. 2018. Efficient Circuit-Based PSI via Cuckoo Hashing. In EUROCRYPT.
[58] Benny Pinkas, Thomas Schneider, and Michael Zohner. 2014. Faster Private Set Intersection Based on OT Extension. In USENIX
[59] Benny Pinkas, Thomas Schneider, and Michael Zohner. 2016. Scalable Private Set Intersection Based on OT Extension. IACR Cryptol. ePrint Arch. 2016 (2016), 930. http://eprintiacr.org/2016/930
[60] Benny Pinkas, Thomas Schneider, and Michael Zohner. 2018. Scalable Private Set Intersection Based on OT Extension. ACM Trans. Priv. Secur. 21,2 (2018), 7:1-7:35. https://doi.org/10.1145/3154794
[61] Raluca Ada Popa, Catherine MS Redfield, Nickolai Zeldovich, and Hari Balakrishnan. 2011. CryptDB: protecting confidentiality with encrypted query processing. In Proceedings of the Twenty-Third ACM Symposium on Operating Systems Principles. 85-100.
[62] Amanda C. Davi Resende and Diego F. Aranha. 2017. Unbalanced Approximate Private Set Intersection. IACR Cryptol. ePrintArch. 2017 (2017), 677. http://eprint.iacr.org/2017/677
[63] Peter Rindal. [n.d.]. libPSI: an efficient, portable, and easy to use Private Set Intersection Library. https://github.com/osu-crypto/libPSI.
[64] Peter Rindal and Mike Rosulek. 2017. Improved Private Set Intersection Against Malicious Adversaries. In EUROCRYPT.
[65] Peter Rindal and Mike Rosulek. 2017. Malicious-secure private set intersection via dual execution. In CCS.
[66] Avishay Yanai Ryan Deng Raluca Ada Popa Joseph M. Hellerstein Rishabh Poddar, Sukrit Kalra. 2020. Senate: A Maliciously-Secure MPC Platform for Collaborative Analytics. IACR Cryptol. ePrintArch. 2020 (2020), 1350.
[67] Mariana Raykova Saeed Sadeghian Seny Kamara, Payman Mohassel. 2014. Scaling Private Set Intersection to Billion-Element Sets. In Financial Cryptography and Data Security. 195-215.
[68] Ranjit Kumaresan Vladimir Kolesnikov. 2013. Improved OT Extension for Transferring Short Secrets. In Crypto (2). 54-70.
[69] Nikolaj Volgushev, Malte Schwarzkopf, Ben Getchell, Mayank Varia, Andrei Lapets, and Azer Bestavros. 2019. Conclave: secure multi-party computation on big data. In Proceedings of the Fourteenth EuroSys Conference 2019. 1-18.
[70] Wikipedia. 2020. Java Native Interface—Wikipedia. https://en.wikipedia.org/wiki/Java_Native_Interface
[71] Song Jiang, Qiuyu Li, Shunde Cao, Pengfei Zuo, Yuanyuan Sun, Yu Hua. 2017. SmartCuckoo: A Fast and Cost-Efficient Hashing Index Scheme for Cloud Storage Systems. In USENIX Annual Technical Conference. 553-565.
[72] Kobbi Nissim Erez Petrank Yuval Ishai, Joe Kilian. 2003. Extending Oblivious Transfers Efficiently. In Crypto. 145-161.
[73] Matei Zaharia, Mosharaf Chowdhury, Tathagata Das, Ankur Dave, Justin Ma, Murphy McCauly, Michael J Franklin, Scott Shenker, and Ion Stoica. 2012. Resilient distributed datasets: A fault-tolerant abstraction for in-memory cluster computing. In Presented as part of the 9th USENIX Symposium on Networked Systems Design and Implementation (NSDI 12). 15-28.
[74] Matei Zaharia, Mosharaf Chowdhury, Michael J. Franklin, Scott Shenker, and Ion Stoica. 2010. Spark: Cluster Computing with Working Sets. In Proceedings of the 2nd USENIX Conference on Hot Topics in Cloud Computing (Boston, MA) (HotCloud′10). USENIX Association, USA, 10.
[75] Samee Zahur and David Evans. 2015. Obliv-C: A Language for Extensible Data-Oblivious Computation. IACR Cryptol. ePrint Arch. 2015 (2015), 1153.
[76] Wenting Zheng, Ankur Dave, Jethro G Beekman, Raluca Ada Popa, Joseph E Gonzalez, and Ion Stoica. 2017. Opaque: An oblivious and encrypted distributed analytics platform. In 14th {USENIX} Symposium on Networked Systems Design and Implementation ({NSDI} 17). 283-298.

1. A method comprising performing, by a first party computing system:
tokenizing a first party set of data records, thereby generating a tokenized first party set, wherein the tokenized first party set comprises a plurality of first party tokens;
generating a plurality of tokenized first party subsets by assigning each first party token of the plurality of first party tokens to a tokenized first party subset of the plurality of tokenized first party subsets using an assignment function;
for each tokenized first party subset of the plurality of tokenized first party subsets:
performing a private set intersection protocol with a second party computing system using the tokenized first party subset and a tokenized second party subset corresponding to the second party computing system, thereby performing a plurality of private set intersection protocols and generating a plurality of intersected token subsets;
combining the plurality of intersected token subsets, thereby generating an intersected token set; and
detokenizing the intersected token set, thereby generating an intersected set of data records.

2. The method of claim 1, wherein the assignment function comprises a lexicographical ordering function, and wherein generating the plurality of tokenized first party subsets by assigning each first party token of the plurality of first party tokens to one of the plurality of tokenized first party subsets using the assignment function comprises:
assigning each first party token to a corresponding tokenized first party subset based on a lexicographical ordering of the plurality of first party tokens.

3. The method of claim 1, further comprising, prior to performing the private set intersection protocol, for each tokenized first party subset of the plurality of tokenized first party subsets:
determining a padding value, the padding value comprising a difference between a size of the tokenized first party subset and a target value;
generating a plurality of random dummy tokens, the plurality of random dummy tokens comprising a number of random dummy tokens equal to the padding value; and
assigning the plurality of random dummy tokens to the tokenized first party subset.

4. The method of claim 1, wherein the first party computing system comprises a first party server and a first party computing cluster, the first party computing cluster comprising a first party driver node and a plurality of first party worker nodes, and wherein the plurality of private set intersection protocols are performed by the plurality of first party worker nodes.

5. The method of claim 1, wherein the first party set corresponds to a set of join keys corresponding to a private database table join query, and wherein the method further comprises:
receiving one or more filtered second party database tables from the second party computing system;
filtering one or more first party database tables using the intersected set, thereby generating one or more filtered first party database tables; and
joining the one or more filtered first party database tables and the one or more filtered second party database tables, thereby generating a joined table.

6. The method of claim 1, further comprising retrieving the first party set from a first party database.

7. The method of claim 1, wherein the first party set comprises a plurality of first party elements, wherein the plurality of first party tokens comprise a plurality of hash values, and wherein tokenizing the first party set comprises generating the plurality of hash values by hashing each first party element using a hash function.

8. The method of claim 1, wherein the first party set and the second party set comprise an equal number of elements.

9. The method of claim 1, wherein the intersected token set comprises a union of the plurality of intersected token subsets, and wherein combining the plurality of intersected token subsets comprises determining the union of the plurality of intersected token sub sets.

10. The method of claim 1, further comprising:
prior to tokenizing the first party set:
receiving a request message from an orchestrator computer, the request message indicating the first party set, and
retrieving the first party set from a first party database; and
transmitting, to the orchestrator computer, the intersected set, wherein the orchestrator computer transmits the intersected set to a client computer.

11. (canceled)

12. The method of claim 1, wherein the plurality of tokenized first party subsets and a plurality of tokenized second party subsets comprise a predetermined number of subsets, wherein each tokenized first party subset is associated with a numeric identifier between one and the predetermined number of subsets, inclusive, wherein the assignment function is a hash function that produces hash values between one and the predetermined number of subsets, inclusive, and wherein assigning each first party token of the plurality of first party tokens to one of the plurality of tokenized first party subsets comprises:
for each first party token of the plurality of first party tokens:
generating a hash value using the first party token as an input to the hash function; and
assigning the first party token to the tokenized first party subset with the numeric identifier equal to the hash value.

13. A method comprising performing, by a first party computing system:
receiving a private database table join query, the private database table join query identifying one or more first database tables and one or more attributes;
retrieving the one or more first database tables from a first party database;
determining a plurality of first party join keys based on the one or more first database tables and the one or more attributes;
tokenizing the plurality of first party join keys, thereby generating a tokenized first party join key set, wherein the tokenized first party join key set comprises a plurality of first party tokens;
generating a plurality of tokenized first party subsets by assigning each first party token of the plurality of first party tokens to a tokenized first party subset of the plurality of tokenized first party subsets using an assignment function;
for each tokenized first party subset of the plurality of tokenized first party subsets:
performing a private set intersection protocol with a second party computing system using the tokenized first party subset and a tokenized second party subset corresponding to the second party computing system, thereby performing a plurality of private set intersection protocols and generating a plurality of intersected token subsets;
combining the plurality of intersected token subsets, thereby generating an intersected token set;
detokenizing the intersected token set, thereby generating an intersected join key set;
filtering the one or more first database tables using the intersected join key set, thereby generating one or more filtered first database tables;
receiving, from the second party computing system, one or more filtered second database tables; and
combining the one or more filtered first database tables and the one or more filtered second database tables, thereby generating a joined database table.

14. The method of claim 13, wherein the private database table join query additionally comprises a “where” clause, and wherein the method further comprises, prior to determining the plurality of first party join keys:
pre-filtering the one or more first database tables based on the where clause.

15. The method of claim 13, wherein each first party join key of the plurality of first party join keys corresponds to an attribute of the one or more attributes, and wherein tokenizing the plurality of first party join keys comprises:
for each attribute of the one or more attribute, concatenating each first party join key corresponding to the attribute, thereby generating a plurality of concatenated first party join keys; and
hashing each concatenated first party join key of the plurality of concatenated first party join keys, thereby generating a plurality of hash values, wherein the tokenized join key set comprises the plurality of hash values.

16. The method of claim 13, further comprising transmitting the one or more filtered first database tables to the second party computing system, wherein the second party computing system combines the one or more filtered first database tables and the one or more filtered second database tables, thereby generating the joined database table.

17. The method of claim 13, wherein the private database table join query is received from an orchestrator computer, and wherein the method further comprises transmitting the joined database table to the orchestrator computer, wherein the orchestrator computer transmits the joined database table to a client computer.

18. The method of claim 13, further comprising:
generating a token column comprising tokenized first party join keys of the tokenized first party join key set; and
appending the token column to the one or more first database tables.

19. The method of claim 18, wherein filtering the one or more first database tables using the intersected join key set comprises:
removing one or more rows from the one or more first database tables based on the token column, the one or more rows corresponding to one or more tokenized first party join keys that are not in the intersected join key set.

20. A first party computing system comprising:
a first processor; and
a first non-transitory computer readable medium coupled to the first processor, the first non-transitory computer readable medium comprising code, executable by the first processor for implementing a method comprising:
tokenizing a first party set of data records, thereby generating a tokenized first party set, wherein the tokenized first party set comprises a plurality of first party tokens;
generating a plurality of tokenized first party subsets by assigning each first party token of the plurality of first party tokens to a tokenized first party subset of the plurality of tokenized first party subsets using an assignment function;
for each tokenized first party subset of the plurality of tokenized first party subsets:
performing a private set intersection protocol with a second party computing system using the tokenized first party subset and a tokenized second party subset corresponding to the second party computing system, thereby performing a plurality of private set intersection protocols and generating a plurality of intersected token subsets;
combining the plurality of intersected token subsets, thereby generating an intersected token set and
detokenizing the intersected token set, thereby generating an intersected set of data records.

21. The first party computing system of claim 20, further comprising a computing cluster comprising a driver node and a plurality of worker nodes, wherein the first processor and the first non-transitory computer readable medium correspond to a first party server, wherein the driver node comprises a second processor and a second non-transitory computer readable medium coupled to the second processor, wherein each worker node of the plurality of worker nodes comprises a third processor of a plurality of third processors and a third non-transitory computer readable medium of a plurality of third non-transitory computer readable mediums, each third non-transitory computer readable medium coupled to a corresponding third processor.
